(19) United States
(12) Patent Application Publication
(10) Pub. No.: US 2013/0339099 A1
(43) Pub. Date: Dec. 19, 2013

(54) METHOD AND SYSTEM FOR BUSINESS PROGRAM AND SERVICE PLANNING, DELIVERY AND MANAGEMENT

(71) Applicant: Daood Aidroos, Ottawa (CA)

(72) Inventor: Daood Aidroos, Ottawa (CA)

(21) Appl. No.: 13/906,768

(22) Filed: May 31, 2013

Related U.S. Application Data
(60) Provisional application No. 61/660,128, filed on Jun. 15, 2012.
(60) Provisional application No. 61/679,187, filed on Aug. 3, 2012.
(60) Provisional application No. 61/724,510, filed on Nov. 9, 2012.

(51) Int. Cl. G06Q 50/00; G06Q 10/06

(52) U.S. Cl. CPC G06Q 50/01; G06Q 10/0637
USPC 705/7.36

(57) ABSTRACT

Methods and systems for structured communications between business planners to capture and profile a planning and management method as well as tasks, results, and performance indicators for tracking the achievement of a business strategy, goal, or mandate are outlined for an enterprise or an enterprise and its partner organizations. The systems and methods can be used to accelerate the configuration of management information systems and/or enterprise information systems in accordance with those profiles for the purposes of planning, delivering and managing programs and services.

### CROSS-REFERENCE TO RELATED APPLICATIONS

This patent application claims priority from U.S. Provisional Patent Application 61/660,128 entitled “Methods and Systems for Program and Service Planning, Delivery, and Management” filed Jun. 15, 2012; from U.S. Provisional Patent Application 61/679,187 entitled “Methods and Systems for Program and Service Planning, Delivery, and Management” filed Aug. 3, 2012; from U.S. Provisional Patent Application 61/724,510 entitled “Methods and Systems for Program and Service Planning, Delivery, and Management” filed Nov. 9, 2012; from U.S. Provisional Patent Application 61/812,727 entitled “Promise Lifecycle Management Methods and Systems for Productivity Improvement” filed Apr. 17, 2013; and from U.S. patent application Ser. No. 13/906,768 entitled “Method and System for Business Program and Service Planning, Delivery and Management” filed May 31, 2013; the entire contents of all these applications being included herein by reference.

### FIELD OF THE INVENTION

This invention relates to methods and systems for business planning and strategy management for the purposes of managing and improving organizational collaboration through online multimedia discussion groups and social media services generally; of capturing the results of business dashboard system design exercises among parties to such plans and strategies; of providing web-enabled online multimedia environments and web services generally that instantiate such methods and systems; and of providing such web services for promoting, assessing, benchmarking, advising on, provisioning, and acquiring dashboard systems or components of such systems.

A business dashboard system provides ongoing information on the performance of a business plan, program or service over its lifetime as prepared by, and according to parameters specified by, those accountable, responsible or answerable for the business and who want to inform their ongoing business decisions to maximize the likelihood of achieving desired results of the plan. Such results may pertain to, but are not limited to, the performance of one or more of the business enterprise's governance, management, culture, business model, vision, mission, strategy, policies, standards, plans, programs, products or other deliverables, services, processes, intellectual property, organizational design, organizational management framework (e.g. balanced scorecard), personnel, work activities or collections of related activities, workflows, information systems, strategic alliances, data architectures, system architectures, network architectures, hardware and virtualized hardware, software and virtualized software, networks and virtualized networks as well as the historical or planned results pertaining to the above.

Within the prior art there are references to the many forms of plans, e.g. business plans, entered into by people and organizations thereof to achieve what they could not on their own. Within these plans there may be many forms of promises entered into by many different groups including, for example individuals, groups, teams, organizations and enterprises, and with each promise relating to an undertaking by one or more groups with respect to an element of the plan.

The prior art speaks to various forms of results sought to be achieved through such plans to the mutual satisfaction of the parties to such plans, such results possibly including sanctions to one or more parties in the event the desires of all parties are not met. Prior art also speaks to the various functions in organizations having the purpose of business, program and service (BPS) planning, delivery and management (PDM), now referred to as business planning and management. Such organizational functions are understood by the plans (promises) they make. For example the governance function of an enterprise may prepare a strategic plan in response to a promise to the enterprise's shareholders to implement a strategy. Such plans (promises) often include conditions, for example, that such a strategic plan would be implemented upon receipt of a certain amount of shareholder investment with the promise to increase shareholder value by a certain amount.

Within the prior art it taught for such plans (promises) to be recorded in machine-readable format such as a text or spreadsheet file, now referred to as instruments. In addition to such strategic and investment plans, other planning (promissory) instruments may for example include articles of incorporation, terms of reference for advisory bodies, and performance-based compensation contracts with a CEO or an enterprise's auditors; in such cases, the instrument or sets of instruments serve as record of one or more plans (promises) among the parties thereto with the understanding each party would fulfil their responsibilities under the plan (promise) in consideration of the anticipated result, that result comprising one or more anticipated benefits, one or more anticipated costs, and one or more risks of costs including for example sanctions to be applied to those parties who would not fulfill their responsibilities (promises). In addition to governance, other organizational functions that make plans (promises) to increase the likelihood of achieving results include management that may record them in other instruments of the enterprises such as organization charts, terms of reference of committees, cheque signing authority levels of personnel, and job descriptions for example.

Accordingly the prior art often speaks to plans (promises) of Line of Business (LoB) functions, such as sales or emergency response, in instruments such as procedure manuals, workflow diagrams, and user requirements of an Enterprise Information System (EIS) to assist users to fulfill such functions. EIS may be acquired to assist users providing LoB support functions as well, such as the accounting, legal, and information systems functions. This latter function that may itself create an EIS as well as other instruments such as system architecture designs, business rules, software configurations, hardware specifications or software programs to assist users to achieve planned results (fulfill their promises). Such users are typically internal to the enterprise establishing the EIS but they may be external as well.

Further, the prior art often speaks to the responsibilities of said parties to jurisdictions (e.g. to remit tax), organizations (e.g. to adhere to best practices for meeting a product or service quality standard), societies (e.g. to abide by professional principles and practices of accountants), technical, socioeconomic or political organizations (e.g. those with responsibility for industry, de facto, international and other practices and standards in matters pertaining to pollution emissions, web markup language syntax, citizen vote eligibility requirements and so forth), and multilateral bodies (e.g. bills of rights, cross-border travel policy). Further, the prior art speaks to personal, organizational, community and jurisdictional plans (promises) that are created based on existing ones, or changed to address evolving interests, mandates, level of trust among parties, and compliance requirements. Examples include organizations that have agreed to partner and on that promise may incorporate their venture. A CIO's policy advisory function may modify the organization's promises instantiated in EIS instruments to address new government privacy legislation. Two people who have agreed to marry may make a vow and e-sign a marriage license instrument. An advisory committee to a standards setting body, such as the International Standards Organization or the World Wide Web consortium, may prepare a technical instrument that would enhance performance of an existing standard instrument, such as that for the HTML5 open standard based on earlier versions.

Often the prior art speaks to the dynamic nature of instruments over their lifecycle as they are enhanced based on past performance, namely as their adoption by or with other parties changes. In this way, instruments may evolve from being adopted by greater or fewer people as by a person (e.g. a vow of faith), by a group of people skilled in an art (e.g. a professional standard), by an organization (e.g. a Constitution), or a group of organizations (e.g. an industry standard), or a community (e.g. a de facto standard), or jurisdictions (e.g. national legislation). And the changes in adoption of instruments by people and duly authorized representatives of organizations may result their adoption by other people and organizations, as when a multilateral organization ratifies an instrument (e.g. bill of rights for children) that is thereby adopted by all members.

Often the prior art speaks to two large and related classes of self-referencing instruments, one for administering instruments, and one for administering instrument content. The former is typified by e-mail software for sharing and storing instruments, often referred to as transaction processing and database systems, and the latter is typified by document authoring and filing systems, often referred to as document processing (originally, word processing) and content management systems. Both classes of instrument have improved the likelihood of achieving results (or plans and/or promises) through enhanced organizational communications when these are connected through devices having human-machine interfaces (HMI) to local area, wide area, multi-node, software-designed, satellite, telephony, cellular, Intranet and Internet networks to create what is commonly called the Global Network of Computers, or the World Wide Web (WWW), and the services it provisions through various stationary, mobile and wearable access points. Prior art speaks to persons interfacing through HMI to the WWW using such devices as cell phones, keyboards, biosensors and emitters among many others, and often synchronously through multiple media (e.g. voice, text, and audiovisual).

It would also be evident to one of skill in the art that the prior art speaks to this enhanced communication capability through the evolution of the WWW as new standard instruments are adopted. The first HTML open standard instrument is attributed by many with an important role in creating vast numbers of Internet-accessible web pages, or the so-called Web 1.0 wares and services. This “one for all” instrument enables one content producer to communicate with many WWW users as done, for example, by traditional news organizations. Similarly, the JavaScript Object Notation (JSON) open standard contributed to add “all for one” functionality to Web 1.0, often referred to as Web 2.0, which enables one user to communicate bi-directionally with many users as it addresses human-readable data interchange. This is useful, for example, for organizations to securely and privately fulfill plans (promises) through instruments such as sales orders or library book reservations. And with changes to the content of instruments such as web information standards, web browser software and web crawler software, in addition to web service providers taking on the role of brokering information among users as enabled by web services provisioned using advances in both transaction and content software instruments, prior art speaks to Web 2.0 services, or generally web services, such as those commonly referred to as search engines, online communities, and social media.

Accordingly the prior art speaks to real-world content-based machine fulfillment of plans (promises) enabled by improvements to WWW wares and services such as those enabled by biotechnology and other sensors, HMI devices, networks and standards that enable the teleporting of instruments and the record of their fulfillment across time and space with often minimal human intervention. Examples include the telephone-linked Client Relationship Management (CRM) system that records telephone audio of buy-sell plans (promises) in a brokerage's EIS for training and quality assurance purposes, the capturing and linking of the image of an endorsed cheque to the corresponding credit and debit transactions in online banking system networks, the automated collection and reporting of time-of-use electricity consumption data used in utility billing systems, and the automatic payment of such bills through online banking, payment and credit services.

More recent prior art speaks to the emergence of Internet Services Oriented Architectures delivered using “as a Service” (aaS) web service instruments such as Software as a Service (SaaS), sometimes also referred to as Web 3.0. Such aaS and SaaS instruments being exploited to deliver (fulfill) on plans (promises) through so-called hybrid forms of public Internet and private Intranet content management (e.g. ubiquitous office automation suites) and of transaction processing (e.g. CRM) systems. Accordingly, the rise of successful aaS providers lies in their mastery of Web 2.0 to deliver so-called Wed 3.0 services to satisfy the needs of multiple consumers who are in turn producers for multiple consumers, i.e. users delegate responsibility of a plan element to a so-called third party. A typical example is seen when a business traveler uses their enterprise's travel web service provisioned under contract aaS to order a plane ticket that is machine-filled by another organization's web service travel agency instrument. Because under this model the service is offered to clients under a contract or Service Level Agreement (SLA), the organization is operating under a business model of a machine provisioned travel agent or TAaaS that defines Web 3.0, that being a web service for some but not all users or “one for some”.

Further the prior art speaks to the advent of aaS increasingly fulfilling both LoB and LoB support organizational functions through aaS instruments expanding in functionality for sales and telemarketing, client relationship management and service delivery, accounting and finance management and administration, marketing and graphic design, travel arrangement, audit and evaluation, project management, Enterprise Resource Planning (ERP), information and technology and legal services among many others and sometimes called Software, Platform, Management, Governance, Network, Software-Defined Network, Infrastructure or various other “X” aaS where X could be, for example, “P” for Platform as a Service (PaaS).

Accordingly, the prior art speaks to aaS for the purpose of improving all Web 3.0 wares and services such as access authorization to an aaS operating in a multi-tenant environment, interoperability support among aaS to fulfill transactions across aaS provisioned through various aaS, through various networks and their sub-networks, and using system integration support of various aaS. An example demonstrating this is seen when, for confidentiality reasons, an organization may not want its Intranet Sales Reporting EIS to be interoperable with its public or external client-facing Internet aaS CRM and so may take a copy of its CRM sales register once a month and Integrate it into its confidential sales reporting system using what are known as Extract-Transform-Load data integration instruments and now commonly available aaS. However, in this example, should there be a decline in risks of exposure of confidential sales information through the public-facing web service and should the CRM aaS and Sales Reporting aaS systems be Interoperable, then different users of each system may fetch, consume and post to their own system (e.g. to enter a change in a client's address) and be assured the interoperability of both aaS would update the others' system even when there may be many users simultaneously on many virtual instances of each system. Such interoperability would preclude the need to take a monthly copy of the sales register.

Further, the prior art speaks to organizations delegating instrument administration to organizations of organizations, such as standards development organizations, professional societies, industry associations and governments that deliver open and proprietary standards such as ISO-9000, HTML, HDMI and tax codes respectively. The success of an aaS in these circumstances is determined in large part by its ability to quickly consume and deploy changes and additions to wares and services valued by its users, such as those made through improvements to business methods, to communications protocols, to programming codes, to accounting practices, to sensors and to standards. Thus, the CRM aaS provider to telephone financial brokerage firms may see greater adoption off its buy-sell CRM aaS if it supports and is in compliance with the Voice over Internet Protocol (VOIP) standard increasingly being adopted by such brokerages. VOIP is an example of an instrument of organizations of organizations, and when such instruments are provisioned aaS it defines the model of Web 4.0 namely Web 3.0 services for Web 3.0 services, or “some for some”.

Prior art speaks to the automated update of instruments and extending far beyond the ubiquitous updates to desktop software and services. Examples include departments in companies that are clients of aaS and that benefit from functional, security and other improvements to the aaS through automatic or semi-automatic deployment of periodic aaS upgrades, security updates, or applications (apps). Such Web X.0 aaS users thereby further delegate their fulfillment of their organization plans (promises).

Generally the prior art speaks to aaS itself or to the person who subscribes to an aaS for the purposes of creating or fulfilling a plan (promise). Such aaS wares typically comprise 1) software namely computer software and virtual software, non-downloadable web executed software and downloadable computer software, computer applications, computer software programs and computer software application development tools including, but not limited to, programming languages, programming standards, media standards, operating systems, parsers, linkers, loaders and software-defined networks that are provisioned in 2) hardware namely computer hardware including virtual hardware, computers, computer screens, computer chips, desktops, notebook computers, laptop computers, computer servers, tablets, cellular phones, mobile phones, satellite phones, smartphones, telephones, pagers, personal digital assistants, handheld computers, wearable computers, bring-your-own devices (BYOD), computer peripherals and other computing devices with a human-machine interface and provisioned through 3) netware namely the global computer network, namely all connected wide area and local area networks namely networked hardware namely hardware connected to hardware for media storage and communication namely sending, storing, managing, integrating and accessing one or more synchronous or asynchronous, streaming or static personal, professional or organizational media namely data in computer file, literal, alphanumeric, text, voice, audio, haptic, olfaction, image, photograph, video, software, electronic document and electronic form format including business transactions namely calls for proposals, proposals, plans, instruments including contracts and evidence of contract fulfillment through transmission equipment namely hardwired, wireless and virtual computer servers, switches, lines, and other computer and computer network infrastructure to enable users to search and locate information, people and organizations for the purpose of content creation, communication, collaboration, and sharing of software, hardware, netware and media.

Further the prior art speaks extensively to methods and systems for the parties to a plan (promise) to manage risk by enforcing sanctions as anticipated by the planning (promissory) instrument. Such prior art speaks to various management information, decision support and dashboard aaS which may speak to one or more rules and their priority of application to assess plan fulfillment. Such information may be based on measures (e.g. time taken to receive a shipment), measure indicators (e.g. business days between promised and actual date shipped), indicator targets (e.g. +/−1 day, 98% of the time), indicator baselines (e.g. 95% over previous 12 month period), accepted sensors to produce measures (e.g. courier's barcode scanner used to register delivery acceptance at a client site), sensor/interface/device/network and other system error rates (e.g. up to 15 minutes per delivery acceptance), and target tolerances (e.g. +/−1 day in winter, +/−1 hour in summer). Based on such information, prior art speaks to automated and semi-automated methods and/or systems for determination of one or more of 1) the extent of a plan and its fulfillment including satisfaction levels of parties with results or outcomes (e.g. “Shipment was not received according to target nor to client satisfaction”), 2) the extent of any breaches of plans (e.g. “Shipment was received 1 day late, considering tolerances”), 3) the extent of the impact of any breach (e.g. “Level 2—some material impact”), 4) breach resolution mechanisms and resolutions themselves (e.g. “Service Level Agreement—Level 2 breach results in 50% reduction in invoice line item detailing cost of shipment”, 5) the sanction for a breach (e.g. automatic generation of credit note for sanction amount), and 6) sanction enforcement (e.g. establishment of credit note record in supplier's billing system).

Within the prior art the two processes of strategy formulation on the one hand, and business planning and management on the other, are typically performed by different teams of people using often different tools (e.g. web-based software, word processing, spreadsheets, and presentation applications). Once formulated, business planning and management is critical to the success of many diverse organizations, including but not limited to, businesses, charities, governments, government agencies, schools, and not-for-profit organizations. However, planners seeking to capture an organization's strategy often face a significant undertaking, as are the subsequent activities of communicating the plans to implement the strategy, and determining how its implementation will be measured and monitored to inform course corrections by the various stakeholders in the strategy including governments that may collect tax from a successfully implemented strategy.

A strategy may fail for various reasons including due to failings of the linkage between these two processes due to those managing the strategy not realizing that they have differing interpretations of the strategy as formulated, the strategy being outdated even before the process of business planning and management has begun due to the time it takes for managers both to appropriately interpret the strategy and to reach agreement on what management framework will be used to implement it (e.g. an externally sourced framework such as balanced scorecard, an internally developed framework, or a prescribed framework by a standards organization) for aligning strategy implementation activities, those who formulated the strategy not being aware that unanticipated results may require reformulation of the strategy, or that the strategy may be misaligned with other strategies and plans of the organization that are underway.

These issues become even more complex when the strategy affects multiple business units across all or part of an organization or when the execution of the strategy is by different organizations to that formulating the strategy and/or financing the strategy. Consider, for example a mandate given to a US Government department from Jan. 1, 2013 to Dec. 31, 2014 to increase the percentage of all Federal Government contracts entered into with small and minority owned businesses from the current target of 23% to a new target of 25% which would imply increasing contract values to such businesses from approximately $450 billion to approximately $490 billion. Accordingly, fulfilling such a mandate requires a strategy be defined and executed that affects multiple US Government departments, for example the Department of Labor and US Bureau of Labor Statistics together with other Government and private enterprises, including but not limited to, FedBizOpps, SABIT, epipeline, HUBZone, and US Commercial service to provide the necessary support and information to small businesses and minority owned businesses.

With the advent of computers and software there has been a long and varied history of their application to strategy formulation and management, and business generally. Business, hardware, software and networks have been inextricably entwined from the beginning when computers were used simply to calculate numerical values to today's ubiquity of productivity suites, office suites, databases, cloud computing services, and as a Service (aaS) web services. In recent decades there have been significant advances to the robustness and performance of software tools, computer hardware and network infrastructure, and there have been many inventions pertaining to business strategy formulation, management and implementation. However, there have been relatively few business methods leveraging the advances in graphical user interfaces, software, hardware and networking to capture the results of strategy formulation exercises in a way that facilitates business planning, management, implementation, monitoring, improvement and promotion both within the organization and with partner organizations, client organizations and supplier and service provider organizations including governments.

Within the prior art relating to software methods of business automation Flores in U.S. Pat. No. 7,346,529 entitled “Method for Developing an Enterprise Alignment Framework Hierarchy by Compiling and Relating Sets of Strategic Business Elements” describes an enterprise strategy planning system comprising several modules, the first formulates a strategy description based on an assessment of environmental data relating to the business, the second aligns the strategy description with available enterprise resources and responsibilities, and the third measures strategy execution. Accordingly, Flores teaches to a software automation of the prior art continuous improvement process wherein the three modules are adapted to provide a continuous strategy management cycle. Underpinning the invention is a process for rating the alignment of user-provided strategy elements with other user-provided strategy elements using matrices. As such, this imposes a decision-making support process that may not be advantageous for many applications where agreement on strategy elements among multiple users is required before performing alignment in order for convergence on the elements to occur within an economically feasible timeframe; also, elements are drawn upon in one framework in a manner that is independent of how they are drawn upon in another: this also is inefficient and not applicable to many time and cost-sensitive business environments. Further, the method applies to specific businesses in a way that is not suitable for adoption by other businesses that use different alignment frameworks or that have not yet formulated such frameworks.

In contrast Beaven in U.S. Pat. No. 8,095,413 entitled “Processing Management Information” describes a software application where a first set of data is acquired representing a model of an organization with fundamental components, e.g. the people, processes or capabilities. And a second set of data representing a portfolio of management concepts, such as management goals is then acquired and a report generated of these concepts sorted by one or more fundamental components. As such Beaven describes a software tool which automates the consolidation of multiple projects and strategies but does not do so in such a way that builds consensus on the model of the organization itself, nor is it intended to apply to ongoing programs and services delivered by personnel but rather is intended to apply to time-limited strategic initiatives and projects of management. Further, the information captured is not intended to serve in the automated configuring of dashboard systems that will be used to implement the initiative or project.

Similarly, Christiansen et al in US Patent Application 2008/0,255,912 entitled “Framework System and Method for Determining Deliverables Required to Implement a Technology-Enabled Business Change” describes a software application for automating the steps of determining and implementing business change within an organization. Christiansen teaches to a graphical user interface (GUI) driven application where stages in the business change process are defined together with deliverables and components corresponding to each stage and thereafter the assets defined for each component. These different elements may then be selected to provide a customized plan for providing the deliverables defined for implementing the business change. Christiansen therefore provides a software application that consolidates into a database the information normally contained within multiple spreadsheets and documents within an organization. The application, however, is far too comprehensive for smaller organizations to deploy in an economically feasible manner, is not intended for the client (in this case, the clients of EDS) to deploy independently, and it prescribes a model for change management rather than facilitate consensus-building on a dashboard system for those who will experience that change.

Recognizing the issues relating to multiple simultaneous mandates and de-prioritization of long-term strategic plans to address intermediate objectives and immediate short-term activities for area centric issues, Brennan et al in US Patent Application 2008/0,281,651 entitled “Method and System for Managing a Strategic Plan via Defining and Aligning Strategic Plan Elements” describe a software application for managing a strategic plan to address these issues. Accordingly, Brennan teaches to a method of assigning associations of required, desired and strategic business objectives to key result areas (KRAs) which are common to the scorecards of multiple levels within an organization. As such, Brennan teaches that via such KRAs the activities of different levels are aligned with respect to monitoring progress to the objectives for these different organizational levels. The method, however, prescribes a structure of alignment of outcomes and activities for strategy management rather than facilitate consensus-building on what structure should be used by those who will be accountable for achieving the outcomes, does not inform the configuration of the information systems used to implement the strategy, nor are the results suited to commercialization within a client-provisioned marketplace.

Guiding the generation of a strategic plan is addressed by Olsen et al in US Patent Application 2009/0,037,241 entitled “Automated Strategic Planning System and Method” which describes a guided method for creating corporate goals, and from the goals creating action items. The action items are then used to create department goals and therein the department action items which become individual goals from which individuals set individual action items. Scorecards at different hierarchy levels of the organization are aggregated, at least partially, to produce the scorecard for a higher level. The method, like Brennan, prescribes a structure of alignment of outcomes and activities for strategy management rather than facilitate consensus-building on what structure should be used by those who will be accountable for achieving the outcomes, does not inform the configuration of the information systems used to implement the strategy, nor are the results suited to commercialization within a client-provisioned marketplace.

Farooq et al in US Patent Application 2009/0,192,867 entitled “Developing, Implementing, Transforming, and Governing a Business Model of an Enterprise” teaches, similarly to Flores, an integrated framework that integrates across business functions and portfolios and provides an iterative convergence closed-loop model for optimization and transformation of a business model. However, unlike Flores, Farooq teaches to optimizing business models for an organization with reference to industry performance benchmarks and business capability levels. Additionally, similar models with related structure and historical data are used for analyzing and benchmarking. In establishing the business transformation roadmap, a candidate future business model is given various input constraints such as budget, timeline, and resources wherein graphically depicted outcomes allow management to choose a transformation or business model with their target capability levels, prior to operationalizing the business model. However, Farooq treats the organization as single a self-contained entity and facilitates a transformation by performing analysis using convergence analysis based on benchmarks. However, many strategies to enact mandates, and their associated business models, have no benchmark, for example government strategies may involve theories for enabling social outcomes, and these may involve multiple organizations working in ways that have no precedence. Further, Farooq requires user input in development of business models, however there may not be agreement in an organization on what that input should be.

Cantor et al in US Patent Application 2010/0,161,371 entitled “Governance Enactment” describes at an abstract level software systems for supporting a governance solution within an organization in terms of assessing, defining, implementing deploying, and executing the governance solution. Cantor describes a series of modules including a model component to provide definitions and semantics of the entity being governed and a relationship between that entity and an operational model of the organization. However, Cantor is limited to governance models and tools for organizations and does not extend to the broader needs of the day to day activities of people and their alignment with organizational goals, the enablement of a marketplace for promoting these models, nor a means for arriving at a consensus on the models and tools in the first place.

With respect to documenting and communicating a strategy D'Albis et al in US Patent Application 2010/0,262,443 entitled “Systems and Methods Associated with a Collaborative Strategy Editor” describes a software application intended to combine the definition of a strategy and the communication/measurement of progress within a single application environment, and such a software application being intended to consolidate the separate independent efforts of different teams of people using a variety of different software tools into a single software environment and provide traceability of different elements, such as responsibilities, objectives, and KPIs. D'Albis does not, however, empower the user with the real-time and interactive capabilities offered by typical web and social media services, nor does the invention serve to define dashboard systems, and while it does assist to communicate strategic plans to those responsible for implementing them, it doesn't enable the configuration of enterprise systems for tracking strategy implementation.

In addition to software systems addressing the automation of business methods there have been many examples in the prior art of approaches to address the generation and monitoring of performance indicators and the accessibility of data within an organization. For example Marpe et al in U.S. Pat. No. 6,571,235 entitled “System for Providing an Interface for Accessing Data in a Discussion Database” describes a method allowing information provided by multiple users to be accessed by users with an interest in categories of information pertaining to a business specific activity, e.g. a merger and acquisition transaction. Whilst the background of Marpe describes business strategy concepts the core concept against the prior art is increased storage flexibility and data access methodologies for information which is traditionally an issue within business environments that information is compartmentalized and essentially the user must know what to search for before starting. Such methodologies are now commonly referred to as “data-mining”; however the data that is mined is used to inform decision makers, not to configure enterprise software systems.

In contrast Tien et al in U.S. Pat. No. 7,716,592 entitled “Automated Generation of Dashboards for Scorecard Metrics and Subordinate Reporting” describe an interactive dashboard for providing scorecard presentations together with subordinate reports that are automatically generated and configured based on centrally managed metadata definitions. As such the dashboard may be customized based on subscriber credentials, past preferences, etc. and allows members of an organization to therefore view the dashboard. Accordingly Tien teaches to allowing user customization of a dashboard to their preferences wherein such dashboards are computer generated implementations of prior art semi-standard structured reports used by managers to keep track of an activity by the staff within their control. Tien does not, however, provide any direction on the information to be tracked by the dashboard, nor how an organization is to arrive at a consensus on what that information should be, nor how to ensure that the dashboards of users are to be aligned towards common goals.

Razvi et al in US Patent Application 2006/0,235,778 entitled “Performance Indicator Selection” describe a system for selecting performance indicators that are relevant for an organization's business strategies based upon using a questionnaire tool to present questions to a user. Then the software generates a list of recommended performance indicators and optional performance indicators for the organization. Such a method therefore is unable to design new performance indicators, nor align those indicators in accordance with a management framework such as balanced scorecard or COBIT, nor deploy those indicators on generally available enterprise systems.

Addressing part of this issue the prior art of Evans in US Patent Application 2005/0,144,022 entitled “Web-Based System, Method, Apparatus and Software to Manage Performance Securely across an Extended Enterprise and between Entities” describes a web-based software solution that enables capture, integration, filtration, aggregation and collaboration of corporate performance-related data from multiple systems in a secure environment. The software application of Evans being targeted at removing dependency upon strictly defined or proprietary platforms as well as lowering implementation costs to allow small and medium enterprises to exploit business intelligence tools and services. Like Tien, however, the invention does not provide any direction on the information to be tracked by the dashboard, nor how an organization is to arrive at a consensus on what that information should be, nor how to facilitate the alignment of the dashboards comprising those key performance indicators (KPIs) in an organization if that organization uses a management framework other than balanced scorecard.

Venkatasubramanian et al in US Patent Application 2011/0,295,656 entitled “System and Method for Providing Balanced Scorecard Based on a Business Intelligence Server” describes a scorecard software application which defines an internal data structure holding a plurality of strategy components and one or more KPIs. Each strategy component is populated based on the inputs from different data sources storing data in different formats. Accordingly, Venkatasubramanian teaches to a Business Intelligence (BI) system for integrating data from multiple sources to establish the data for generating a KPI, however, does not provide any direction on the information to be tracked by the dashboard, nor how an organization is to arrive at a consensus on what that information should be, nor how to facilitate the alignment of the dashboards comprising those KPIs in an organization if that organization uses a management framework other than balanced scorecard.

Examples of other prior art patents and patent applications addressing aspects of strategy implementations and establishing business strategies, program goals, and project plans include U.S. Pat. Nos. 6,571,235; 7,346,529; 7,401,057; 7,415,437; 7,440,978; 7,716,592; 7,739,136; 7,937,281; and 8,095,413 as well as US Patent Applications 2003/0,046,125; 2003/0,083,914; 2003/0,135,399; 2003/0,212,584; 2004/0,068,429; 2005/0,144,022; 2006/0,111,921; 2006/0,235,778; 2007/0,055,564; 2007,0,106,544; 2007/0,143,159; 2007/0,150,330; 2008/0,255,912; 2008/0,281,651; 2009/0,037,241; 2009/0,076,867; 2009/0,192,867; 2009/0,281,845; 2010/0,070,291; 2010/0,161,371; 2010/0,262,433; 2011/0,0264,592; and 2011/0,295,656.

Much of the prior art described above, often established by larger consulting organizations and/or software organizations, involve many activities centering upon business planning and that are still done using traditional means such as meetings and e-mail and other exchanges between principals, possibly facilitated by consultants. As can be imagined, this together with a plethora of best practices frameworks such as Balanced Scorecard (BSC) and Control Objectives for Information and related Technology (COBIT) result in such means being typically quite inefficient, lengthy, and unwieldy. Meetings require time, energy, and, potentially, travel time with no guarantee of useful results, and at the same time communications between principals can get lost, misdirected, or simply misunderstood. Not only that, but current communications are essentially one-to-one channels which makes it difficult to arrive at a consensus among more than two people. Whilst multiple participants in a discussion via email is possible, most people are familiar with the issues of the unwieldy “reply all” email tactic: such emails can very quickly become overly large, overly complicated, and the issues discussed can very easily get sidetracked or lost where multiple issues are dealt with in a single thread of emails. Further, accountability for who is to do what by when may be lost.

Another challenge for organizations is capturing the results of such communications so that plans are implemented as intended and achieve the results intended. Such a challenge may arise at least in part due to difficulties accessing records of the business planning process, a lack of a common language (e.g. the Business Motivational Model of the Object Management Group) for business planning which may lead to misinterpretations of strategies and plans, an inappropriate or insufficient consideration of one or more other strategies or plans of the enterprise enacting the strategy and/or those of its partner organizations, or an inappropriate or insufficient consideration through the planning process of implementation constraints, among others. Accordingly, part or all of the strategies and plans as formulated and communicated may be inappropriately captured and/or interpreted, and therefore lead to errors in the implementation of the strategies and plans.

The same challenges that arise in capturing and interpreting strategies and plans also arise in capturing and interpreting the characteristics of the system for tracking them. Such a dashboard system serves stakeholders to ensure the strategies and plans are implemented as intended and to make course corrections. An exemplary definition of a dashboard system is a collection of performance indicators and the parameters for tracking them (e.g. alert sales manager when monthly sales performance indicator is less than 50% of target by day 15 of each month) is an example of a dashboard having one measure with one indicator and one target and the collection of dashboards for all persons responsible for an enterprise's strategies and plans may be called a dashboard system (e.g. in addition to sales manager dashboard, alert sales reps when their monthly sales performance indicator is less than 30% of target by day 10 of each month). Thus even though the strategy may be clearly formulated and correctly interpreted by those responsible for implementing it, dashboards systems serve to proactively steward an organizational plan, program or service.

Similarly, the success of joint strategies and plans among multiple enterprises are highly dependent on the collaborating organizations understanding and agreeing on the dashboard system elements within their purview. A lack of consensus may lead to activities of the collaborating organizations being misaligned, thereby putting the achievement of the joint initiative at risk. This is particularly true when organizations engage for the first time, which may occur at a time of important change or even crisis, such as a hostile takeover.

An important aspect of the business planning function is that strategies, plans and dashboard systems for a new or enhanced business, program and/or service should be established in a way that benefits from best practices and lessons learned from other organizations and individuals with relevant experience. Typically the success of such an exercise is highly dependent not on the efficiency and effectiveness with which the planner of the new program or service and the experienced organization communicate and share their experiences but rather the ability of the planner to locate organizations with relevant experience, to understand the information provided by that organization, and to capture findings in a way that can be transparently transferred to the new dashboard system. In current practice, this is often done through commissioning a consultant, possibly internal, to prepare an analysis of the requirements of the new business, program or service, to then seek out organizations with relevant experience, and to attempt to access that experience either by way of interviews, document reviews or other means This process can be resource intensive for both the planning and the experienced organization, and typically would result in a delay in the implementation of the new initiative. Further, communications between these organizations may suffer from the challenges described supra.

Accordingly, it would be evident to one skilled in the art that there exist requirements within many organizations for a method and system that address the limitations within the prior art of business planning and management with respect to dashboard system design and deployment. Such a method and system should address the communication and comprehension issues not only among planners involved in designing plans and dashboard systems but also those responsible for delivering business programs and services under such plans and promises. Ideally, the method and system should engage these planners, organization personnel and their partners to have a full and consensual understanding of the results to be achieved and how the dashboard system should be designed to ensure they each fulfill their responsibilities over time and in response to change. Further, the method and system should be able to quickly, and in a manner that manages risk, enable organizations to respond to disruptions to market or socioeconomic conditions by capturing redesigned plans and dashboards, and reflecting these changes in the organization's production dashboard system and those of its partners. As well, it should allow current and future personnel and authorized third parties to review how strategies and plans were designed or changed and by whom to ensure accountability for performance is attributed and lessons captured for future planning purposes. Further, it should provide for the design and deployment of the dashboard system or system elements in a way that is aligned to the strategies and plans the system is intended to track as a further means of ensuring accountability for performance. It would also be beneficial for planners and/or their organizations, to be able to profile, make accessible and promote their dashboard system and system elements, and the performance thereof, in a way the profiles and dashboard systems could be located, understood, assessed, compared, benchmarked, provisioned, customized, maintained, promoted and/or deployed by other planners, consultants, subject matter experts and/or organizations. Further, it would be beneficial for consultants, standards organizations, regulators and other third parties to be able to profile, make accessible and promote dashboard system elements and the performance thereof, in a way such profiles and elements could be located, understood, assessed, compared, benchmarked, provisioned, customized, maintained, promoted and/or deployed by other planners, consultants and/or organizations to enhance their existing dashboard systems. It would also be beneficial to offer an online multimedia marketplace and knowledge management portal infrastructure for promoting, exchanging and customizing management systems and/or dashboard systems and/or dashboard system elements and the related management consulting services and/or technology consulting services and/or audit and evaluation services. It would also be beneficial if the method and system created dashboard systems and elements such that they could be automatically or semi-automatically deployed on Common Off The Shelf (COTS), cloud-based, custom, legacy or other enterprise information systems and services. Further, it would be beneficial if the method and system could be implemented with lessor dependence on expensive management consultants, human resource consultants, IT specialists and other Line of Business (LoB) support services. Finally, it would be beneficial if the method and system could be implemented with lessor dependence on an organization's existing IT infrastructure and architecture. Ultimately, in this way, such a method and system would impose few, if any, constraints on those responsible for strategy implementation through business, program and service delivery, thereby enabling innovative management within and among organizations and individuals, empowering workers to approach optimal productivity with minimal confusion or misinformation, and instilling pride through performance that is meaningful and attributable.

The embodiments of the invention are intended to address these limitations of the prior art and provide some or all of the benefits outlined supra.

### SUMMARY OF INVENTION

It is an object of the present invention to provide a method and system for designing, deploying and promoting business dashboard systems and system elements for tracking business strategies and plans and to providing web-enabled online multimedia environments and social media generally for organizations to create, locate, understand, assess, compare, benchmark, provision, customize, maintain, promote and/or deploy business dashboard systems or system elements.

In accordance with an embodiment of the invention there is provided a method comprising:
a) providing on a microprocessor based computer system accessible via a network a group multimedia discussion system and an associated social media system for use by at least a participant of a plurality of participants;
b) providing to each participant of the plurality of participants on a microprocessor based device associated with the participant connected to the network access to the group online multimedia discussion system and an associated social media system such that a decision as to the selection of selected planning and management method of a plurality of potential planning and management methods is documented together with all discussions between the plurality of participants leading to the decision;
c) providing on the microprocessor based computer system a plurality of grids, each grid of the plurality of grids for facilitating discussions and detailing decisions arrived at by users in conjunction with the group discussion system and an associated social media system and being part of a multistage process relating to the establishment of at least one of a program and a performance indicator relating to achieving a mandate;
d) providing to each participant of a predetermined subset of the plurality of participants on their microprocessor based device connected to the network access to at least a grid of a predetermined subset of grids of the plurality of grids, the predetermined subset of grids being determined in dependence upon at least the participant and the selected management method; and
e) providing in association with each grid of the predetermined subset of grids participant guidelines for use by each participant of the plurality of participants to guide said discussions in said group discussion system and associated social media system.

In accordance with an embodiment of the invention there is provided a system comprising:
a. a microprocessor based computer system accessible via a network comprising at least a physical non-volatile memory
b. a group discussion module for use by the plurality of participants, the group discussion module and associated social media module allowing each participant of the plurality of participants to employ a microprocessor based device associated with the participant connected to the network access to the group discussion system and an associated social media system such that a decision as to the selection of selected planning and management method of a plurality of potential planning and management methods is documented together with all discussions between the plurality of participants leading to the decision;
c. a plurality of grids stored within the memory of the microprocessor based computer system, each grid of the plurality of grids for facilitating discussions and detailing decisions arrived at by users in conjunction with the group discussion system and associated social media system and being part of a multistage process relating to the establishment of at least one of a business or a program or a service, and a performance indicator relating to achieving a mandate;
d. a grid module for use by each participant of a predetermined subset of the plurality of participants, the grid module allowing each participant of the predetermined subset of the plurality of participants on their microprocessor based device connected to the network access to at least a grid of a predetermined subset of grids of the plurality of grids, the predetermined subset of grids being determined in dependence upon at least the participant and the selected planning and management method; and
e. a guideline module for use in association with each grid of the predetermined subset of grids, the guideline module providing to participants guidelines and tools (e.g. parsers) for use by each participant to guide said discussions in said group discussion system.

In accordance with an embodiment of the invention there is provided a method for capturing a promise made by an enterprise in common terms of art and associated business planning information relating to business, programs and services for the enterprise, the method comprising:
a. providing upon a computer system an online multimedia group discussion system and an associated social media system, said system being for use by participants involved in said enterprise;
b. providing generation with a microprocessor associated with the computer system at least a grid of a plurality of grids and associated social media services within the discussion system based upon the planning and management method identified and selected by said participants for completion by said participants, each said grid of the plurality of grids being for detailing planning and management information and decisions arrived at by said participants in discussions using said social media systems, said decisions being part of a stage of a multistage process;
c. providing a plurality of grids and social media services based on the enterprise planning and management method identified by said participants for completion by said participants, said grids being for detailing promises and decisions arrived at for planning and managing the fulfillment of said promises by said participants in discussions using said social media systems, said decisions being part of a multistage process;
d. providing via the computer system the plurality of grids and associated discussion and social media services based on the language terms of art planning and management method identified by said participants for completion by said participants, said grids being for detailing promises and decisions arrived at by said participants in discussions using said social media systems, said decisions being part of a multistage process;
e. providing a credential based access to the computer system facilitating login for said participants such that participants are able to at least one of participate in and contribute to discussions in accordance with their credentials in said group discussion system;
f. providing a plurality of at least one of guidelines and tools, each of said at least one for use by said participants to guide said discussions and contributions and facilitate establishment and recordation of, and to arrive at and record decisions within said group discussion system by the participants.

In accordance with an embodiment of the invention there is provided a method for establishing planned results and performance indicators for managing fulfillment of said planned results for a business enterprise, the method comprising:

executing a multi-stage process upon a computer system accessible by participants in said enterprise via a network, each stage in the multi-stage process comprising;
a. providing at least one form for completion by participants in said enterprise, said at least one form detailing decisions made by said participants regarding issues relating to said goals and indicators;
b. providing a discussion group system for discussions by said participants, said participants logging in to said discussion group system to participate in said discussions;
c. receiving at least one completed form from said participants at an end of a stage in said process; providing a non-volatile digital memory for storage of completed forms;
d. providing a configuration file for use in reconfiguring a client relations management system of said enterprise, said configuration file being based on completed forms from said participants.

Other aspects and features of the present invention will become apparent to those ordinarily skilled in the art upon review of the following description of specific embodiments of the invention in conjunction with the accompanying figures and in light of the context established above.

### BRIEF DESCRIPTION OF THE DRAWINGS

The embodiments of the present invention will now be described, by way of example only, by reference to the following figures, in which identical reference numerals in different figures indicate identical elements and wherein:

FIG. 1 depicts an exemplary conceptualization according to an embodiment of an aspect of the invention showing different roles to be considered when planning, delivering and managing (PDM) a business, program or service (BPS) and the general task performed in each role at each of three stages of a project to implement the BPS;

FIG. 2 depicts an exemplary conceptualization according to an embodiment of an aspect of the invention showing different exemplary steps in the framework for PDM when viewed from the role of personnel receiving, and being responsible for implementing, management directives for a BPS;

FIG. 3 depicts an exemplary conceptualization according to an embodiment of an aspect of the invention showing different directives provided by management at different steps in the framework for BPS PDM;

FIG. 4 depicts an exemplary conceptualization according to an embodiment of an aspect of the invention showing the alignment of management directives with personnel's implementation steps in the BPS PDM framework as required by those who provide information systems services to users from various LoB and Support functions of an enterprise;

FIG. 5A depicts an exemplary simplified diagram of a program delivered by multiple enterprises each having a mutually aligned dashboard system for that program in accordance with each enterprise's Servicebook™ deployed from a central repository, with the program and performance profiles of those Servicebooks™ also are recorded in that repository;

FIG. 5B depicts an exemplary simplified diagram of a social media system interfacing with a central repository of Servicebooks™ and provisioned through the Global Network of Computers and accessed using various devices and sensors having human machine interfaces (HMI) according to an embodiment of the invention;

FIG. 6 depicts an exemplary block diagram of a Global Network of Computers system integrating storage areas and social media systems for enterprises and where the HMI interfaces are not visible to the human eye according to an embodiment of the invention;

FIG. 7 depicts an exemplary user planning grid after completion of Stage 0 (Scope) of a framework according to an embodiment of an aspect of the invention;

FIG. 8 depicts an exemplary planning grid during completion of Stage 8 (Design Performance Indicators) according to an embodiment of an aspect of the invention;

FIG. 9 depicts an exemplary user dashboard/screen of a Customer Relationship Management (CRM) application after configuration with Servicebook™ parameters according to an embodiment of an aspect of the invention;

FIG. 10 depicts an exemplary audit trail presented to a user for approved social media board entries according to an embodiment of an aspect of the invention;

FIG. 11A depicts an exemplary Activity-Result model according for four aligned BPS functions of an enterprise according to an embodiment of an aspect of the invention;

FIG. 11B depicts an entry being made in accordance with the exemplary planning and management method of FIG. 11A using an exemplary discussion group and demonstrating the selection from an exemplary term form a term set by a participant contributing to the discussion;

FIG. 12 depicts an exemplary network supporting implementation of multiple Servicebooks™ across multiple organizations according to an embodiment of an aspect of the invention; and

FIG. 13 depicts an exemplary electronic device supporting connection to a network and supporting Servicebook™ for a user according to an embodiment of an aspect of the invention.

FIG. 14 provides an excerpt from a multi-party promise of a Regional Innovation Centre (RIC) to provision resources to a company under the stewardship of a Local IC for the purpose of piloting a new product in a commercial setting under a program implemented under an embodiment of the invention.

FIG. 15 presents in one embodiment of the method and system the facet chain for the project promise in FIG. 14 in the form of a project work breakdown structure with each party accepting the respective positions of other parties, as well as a third party fulfillment indicator that assesses promise fulfillment and executes visual sanctions using green, yellow and red colored smiley icons. While the facets of planned cash flows and other resources of each party pertaining to each task are not seen, the index may be being used to automatically recalculate such DSET elements.

FIG. 16 presents in one embodiment of the method and system for the facet chain (terms primarily, some conditions) of an organization's promise to its board.

FIG. 17 presents exemplary roles of a person who is party to a promise (top row), exemplary stages of a promissory lifecycle (left column), and corresponding means of assessing promise fulfillment by role and stage.

FIG. 18 presents exemplary facet chains for a BPS with a mandate in economic development arrived at using a discussion board and social media services generally according to an embodiment of the invention.

The Figures are not to scale, relative positions and locations are demonstrative only, and some features may be exaggerated or minimized to show details of particular elements while related elements may have been eliminated to prevent obscuring novel aspects and/or to aid presentation through improving clarity. Therefore, specific structural and functional details disclosed herein are not to be interpreted as limiting but merely as a basis for the claims and as a representative basis for teaching one skilled in the art to variously employ the present invention.

### DETAILED DESCRIPTION OF THE INVENTION

The following description of the present invention provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It would be evident to one skilled in the art that various changes may be made in the function and arrangement of elements without departing from the spirit and scope as set forth in the appended claims.

Embodiments of the invention relate to methods and systems for business planning and strategy management for the purposes of managing and improving organizational collaboration through online multimedia discussion groups and social media services generally; of capturing the results of business dashboard system design exercises among parties to such plans and strategies; of providing web-enabled online multimedia environments and web services generally that instantiate such methods and systems; and of providing such web services for promoting, assessing, benchmarking, advising on, provisioning, and acquiring dashboard systems or components of such systems. The invention is intended according to the various embodiments of the invention that may be implemented to assist people in creating plans for working together to achieve results they could not achieve on their own such that the fulfillment of these plans may be administered automatically or semi-automatically using software based applications and computing platforms. Results may include, but are not limited to, desired results, undesired results, visions, strategies, income, tactics, intended benefits, intended outcomes, expenses, costs, and unintended outcomes.

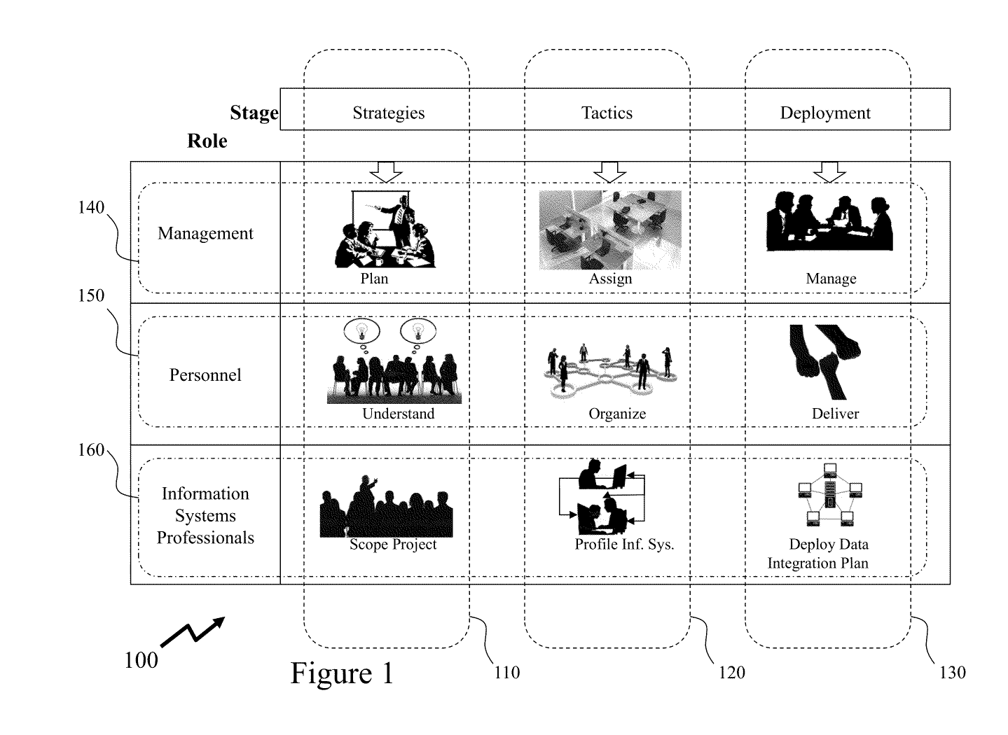

This invention has been described in respect of embodiments of the invention with reference to language and terms familiar to people of skill in the art to within the field of the invention. As such the descriptions in respect of FIGS. 1 through 18 and the specification as a whole are written with respect to software applications and/or software systems being employed by people having the intent of achieving mutual gain by entering into a set of promises and establishing fulfillment of the set of promises through a plan which may further include sanctions in the case of a breach of one or more promises within the set of promises. Accordingly, the descriptions draw on terms of art common to many such promises, including but not limited to those of law (e.g. contract law), governance (e.g. rules of order), management (e.g. performance appraisal), psychology (e.g. organizational behaviour), computer science (e.g. automated data processing), engineering (e.g. machine sensors), mathematics (e.g. additive function properties), linguistics (e.g. subject-predicate-object grammars), philosophy (e.g. logic type), and professional standards (e.g. Generally Accepted Accounting Principles (GAAP) and Practices).

A “software system and/or software application” (SSSA) tool as used herein and throughout this disclosure refers to, but is not limited to, hardware, software, scripting languages, firmware, middleware, microcode, hardware description languages and/or any combination thereof to provide one or more functions to users including, but not limited to, receiving, processing, storing, manipulating, presenting, transmitting, and generating data.

“Data” as used herein and throughout this disclosure refers to, but is not limited to, those aspects of a SSSA relating to the provisioning of formatted information, including for example, that provided through scanning, optical character recognition, alphanumeric, text, voice, audio, haptic interfaces, olfaction, image, photograph, visual, audiovisual, graphic and video formatted information. Further “machine data” as used herein and throughout this disclosure refers to, but is not limited to, those aspects of a SSSA wherein data is stored within the software system and/or software application including, but not limited to, that relating to the execution of the SSSA itself, content input to the software system and/or software application, and information/data generated by the SSSA during execution.

A “promise lifecycle” as used herein and throughout this disclosure refers to, but is not limited to, those aspects of a SSSA relating to the timing of the fulfillment of a promise or plan, such as, for example, closing the a sale of a house by a date within a purchase/sale agreement.

A “promissory note” as used herein and throughout this disclosure refers to, but is not limited to, those aspects of a SSSA relating to the minimum acceptable evidence of the extent that a promise or an element thereof is fulfilled in accordance with its promise lifecycle, such as, for example, a waived condition on a purchase/sale agreement.

“Electronic file” as used herein and throughout this disclosure refers to, but is not limited to, those aspects of a SSSA stored internally relating to machine interpretable datasets that may be synchronously or asynchronously provisioned in a manner intelligible to another machine or to a human through one or more human-machine interfaces and that may be accessed, provisioned, maintained and archived by people or organizations thereof. Examples include electronic documents, spreadsheets, databases, templates, folders, lists, libraries, forms, data models, and web standards. An example of the latter is the World Wide Web Consortium document type definition (DTD) standard that serves a machine to interpret a file, in the HTML file example this could be done inside a .txt file with the content <!doctype html>;

A “measure” as used herein and throughout this disclosure refers to, but is not limited to, those aspects of a SSSA relating to the metric as agreed to by parties to a promise for calculating promise fulfillment based on data at least one of provided to, acquired by, and generated by the SSSA. An “indicator” as used herein and throughout this disclosure refers to, but is not limited to, those aspects of a SSSA relating to a measure when the measure is applied to data within the SSSA to generate SSSA derived data, called values of the indicator for the measure. For example “planned delivery date” and “actual delivery date” may be measures and the difference between them an indicator.

A “result” as used herein and throughout this disclosure refers to, but is not limited to, those aspects of a SSSA relating to the machine data generated from machine interpretable instructions agreed to by parties for calculating fulfillment level of a promise based on one or more indicator values over a promise lifecycle. For example, a baseline for an indicator could be the indicator calculated over a period prior to a promise, a target could be that value augmented by 10%, and the result could be the mathematical difference between the indicator calculated since the promise and the target.

A “satisfaction level” as used herein and throughout this disclosure refers to, but is not limited to, those aspects of a SSSA relating to the data generated by using results as indicators and agreed to by parties to a promise to represent the fulfillment extent of a promissory note.

A “virtual community” as used herein and throughout this disclosure refers to, but is not limited to, those aspects of a SSSA relating to two or more people who agree to having an equivalent satisfaction level with machine data, for example as measured by comparing their “likes” recorded in social media services.

An “agreement” as used herein and throughout this disclosure refers to, but is not limited to, those aspects of a SSSA relating to an object, e.g. an electronic document, that represents a promise comprising one or more promissory notes or electronic promises among one or more people and that is verifiable to them. A “representative as used herein and throughout this disclosure refers to, but is not limited to, those aspects of a SSSA relating to a person or people party to an agreement either directly relating to a promise or working on behalf of another. An “organization” as used herein and throughout this disclosure refers to, but is not limited to, those aspects of a SSSA relating to a legal entity having objects and the capacity to acquire and provide products or services.

A “record” as used herein and throughout this disclosure refers to, but is not limited to, those aspects of a SSSA relating to machine data verifying that a promissory note has been fulfilled. A “party to an agreement” as used herein and throughout this disclosure refers to, but is not limited to, those aspects of a SSSA relating to the signatories to an agreement, an organization associated with a signatory, and an organization that accepts as a record an agreement entered into by one of its representatives. An “instrument” as used herein and throughout this disclosure refers to, but is not limited to, those aspects of a SSSA relating to an electronic agreement that all parties agree to fulfill and that each party accepts as a record. A “facet” as used herein and throughout this disclosure refers to, but is not limited to, those aspects of a SSSA relating to an instrument that is common to all parties to the instrument.

A “fulfilled result” as used herein and throughout this disclosure refers to, but is not limited to, those aspects of a SSSA relating to an outcome expressed as a facet of an agreement that has been fulfilled by completion of associated activities or its metric exceeding a predetermined agreed threshold to denote completion of said activity. Such fulfilled results may include, but not be limited to, a duly completed transaction or a transaction verifiable by a machine, such as for example revenue exceeds $X, transferring funds from account X to account Y if received date is equal to or earlier than promised date, and all electronic signatures received authorizing release of document.

A “document set” as used herein and throughout this disclosure refers to, but is not limited to, those aspects of a SSSA relating to retrievable information agreed by all parties to fully demonstrate the fulfillment of a promise. An “instrument set” as used herein and throughout this disclosure refers to, but is not limited to, those aspects of a SSSA relating to a machine interpretable document set which may be interpreted by a machine to demonstrate that a promise has been fulfilled together with or independent of any included or assessed sanctions. An “instrument record set” as used herein and throughout this disclosure refers to, but is not limited to, those aspects of a SSSA relating to the minimum facets that must be records for the promise to be deemed fulfilled by all parties.

A “portable electronic device” (PED) as used herein and throughout this disclosure, refers to a wireless device used for communications and other applications that requires a battery or other independent form of energy for power. This includes, but is not limited to, devices such as a cellular telephone, smartphone, personal digital assistant (PDA), portable computer, pager, portable multimedia player, portable gaming console, gauging and measuring devices, laptop computer, tablet computer, 3-D rendering displays, haptic feedback devices, wearable computing devices, biofeedback devices, solar powered computing devices, cameras, video devices, haptic devices, human powered devices and sensors and electronic readers. A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled environmental sensor, an Internet enabled television, and a multimedia player.

The terms “coupled” and “connected”, along with their derivatives, are used herein and throughout this disclosure. It should be understood that these terms are not intended as synonyms for each other. Rather, in particular embodiments/instances, “connected” may be used to indicate that two or more elements are in direct physical or electrical contact with each other whilst in other embodiments/instances it may be used to indicate that input(s)/output(s) of an activity or activities, application element etc. receive/provide information from/to another activity or activities, application element etc. “Coupled” may be used to indicated that two or more elements are in either direct or indirect (with other intervening elements between them) physical, wireless or electrical contact with each other, or that the two or more elements co-operate or interact with each other (e.g. as in a cause and effect relationship) via input(s)/output(s).

Within the following description of embodiments of the invention “Client Station” is used to describe a wired and/or wireless device, such as a PED and/or FED, used by a user for communications with a SSSA and/or network application and/or network system in order to execute one or more actions and/or partake in one or more activities in accordance with the invention.

A “user” as used herein and throughout this disclosure refers to, but is not limited to, a person or device that utilizes a SSSA according to an embodiment of the invention and as used herein may refer to a person, group, or organization that has registered with the SSSA and/or network application and/or network system to at least one of establish, design, manage, develop, use, maintain, compare, analyze, exploit, deploy or acquire at least one of a dashboard system or element thereof. A “user interface” or “human machine interface” as used herein and through this disclosure refers to, but is not limited to, a graphical user interface (GUI) and/or web-based user interface (WUI) which accepts user input from one or more user or other input devices and/or provides output to the user or users or other output devices. Typically the user interface will provide articulated graphical input/output on one or more displays and/or input-output devices of an electronic device but may also provide articulated graphical output in conjunction with audio and/or tactile output as well as accepting input or generating output through audio, olfactory, taste, visual, and haptic interfaces.

A “software system” or “network system” as used herein and through this disclosure refers to a computer, server, or other microprocessor based device either alone or in combination with other microprocessor based devices communicating with one another via at least one telecommunications protocol to support one or more software applications providing one or more functions associated with the invention including those for users, registered parties, associated organizations, and others accessing an embodiment of the invention. A “software application” as used herein and through this disclosure refers to a set of programs, procedures, algorithms and associated documentation concerned with the operation of a data processing system according to embodiments of the invention relating to providing one or more functions associated with the invention including those for users, registered parties, associated organizations, and others accessing the system or using the method.

A Servicebook™ as described with respect of embodiments of the invention relates to methods, systems, hardware, networks and software for capturing, enhancing, deploying and promoting an enterprise's dashboard systems or elements thereof to PDM a BPS. Within this patent specification and the following descriptions of exemplary embodiments of the invention, “Servicebook™” is used to describe a SSSA and/or business method and/or enterprise information system configuration parameters relating to at least one of establish, design, record, manage, develop, share, discuss or otherwise exchange over social media, use, maintain, compare, analyze, exploit, deploy or acquire at least one of a dashboard system or at least one or more of the following exemplary dashboard system elements these being a shared understanding of the BPS commitments, management methods, implementation team, information system specifications, planned results, workflows for achieving those results, data integration or interoperability strategy required for the information systems to operate in alignment with existing and legacy systems, performance measures, performance indicators and associated alert and other target parameters for tracking the achievement of planned results.

According to embodiments of the Servicebook™ invention a multi-stage and multi-step framework is provided for business planning giving focus and structure to discussions regarding the BPS of an enterprise and that serve to develop Dashboard Systems or Elements Thereof (DSET) for managing those BPS. The organizational functions and the roles of FIG. 1 and authorities of personnel are exemplary and are themselves determined in the planning and management method scoping phase of the invention. The role of the moderator(s) may evolve as the framework is implemented and as established during the scoping phase, at times serving as arbiter, facilitator, contributor, mediator, subject matter expert or advisor to the participants.

Embodiments of the invention also provide a computer implemented framework for developing DSET(s) through providing a guided directional completion of multiple forms, or grids, for each step of the framework. At each step established during the scoping phase, planners are provided with grids whose entries will be the basis for discussions at that step, and whose purpose is to collect information required to design the DSET(s). To facilitate these discussions, bulletin board-style discussion groups and social media services generally are provided so that decision-makers can login and participate in social exchanges regarding the various elements of the DSET(s). As the framework is traversed, these grids and their associated discussions focus the planners on arriving at agreement on the DSET(s) such that the parameters describing them may be automatically or semi-automatically deployed to their enterprises' information systems and, when relevant, in the information systems of the BPS partners. As EIS users conduct the day to day affairs of the BPS, their dashboards are updated by the EIS in accordance with the DSET so that performance may be managed and course corrections may be made.

Embodiments of the invention are directed to providing methods, systems, and software applications for the PDM of BPS by guiding the different planners within an organization or organizations through the framework of stages and roles to plan the tasks of each that will produce the planned results. These planners may be agents with full or partial authority of one hierarchy level of an organization (e.g. Board of Directors) for all roles of the framework, of multiple hierarchy levels of an organization function for all roles of a framework, or varying hierarchy levels or authorities of hierarchy levels for various roles of a framework. Once the DSET is implemented and the performance of the DSET is evident, users may prepare a profile possibly using keywords, term sets and other social media tagging taxonomies and language models to describe the BPS that the DSET was prepared for, and a similar profile of the performance of the BPS using that DSET; then, these profiles may be made available through an online marketplace for others to search, locate and/or acquire DSETs of relevance to their own or another BPS.

According to embodiments of the invention the types of business information that planners may include in scope to prepare DSET(s) for a BPS may include, but are not be limited to:

Commitments to investor(s) funding or otherwise backing the initiative;

Deliverables to investor(s) demonstrating initiative results;

Business method used for planning, delivering and managing the initiative (e.g. balanced scorecard, organizational policies & practices);

Organizational structure with delivery team(s) and/or member(s) accountable or otherwise having responsibility for the BPS;

The information systems for implementing the initiative such as information and technological architectures and hardware infrastructure;

The planned results of those responsible for the initiative;

The tasks and workflows for implementing the initiative;

The base information, such as client and product tombstone data and legacy transaction data required by the information systems to deliver the initiative and to report performance against plans and past performance; and

The performance measures, performance indicators, indicator calculation methods, and indicator value monitoring methods (e.g. comparison with benchmarks, satisfaction level with value from survey) pertaining to the above.

Accordingly, therefore a business planner within the U.S. Patent and Trademark Office of the U.S. Department of Commerce establishing a service of a customer call centre operation could search and identify that two other U.S. Departments (say Education and Labor) have previously established a BPS relating to the same mandate with a DSET that has proven effective and thus the USPTO may deploy that DSET on their own EIS. Additional information accessible to business planners searching a database of published Servicebook™ profiles may include, but not be limited to, duration, cost, improvement achieved, software systems employed and contact information. Optionally, such Servicebooks™ may have some restrictions, e.g. one published by a consulting firm may require that they be engaged as part of the project team, one published by Walgreens may not be employed within the retail pharmacy sector, or that one published by U.S. Department of Labor for monitoring one's compliance is available for a cost that scales with enterprise size so that small businesses can access it free or cheaply whilst larger enterprises must pay a higher fee. Others may be available for example on a performance related or contingency basis such that a fee is paid based upon the success of the BPS after the DSET is deployed.

A software embodiment of the method provides an enterprise, or association of enterprises implementing a common BPS, with a World Wide Web or other network enabled application that business planners can log into anywhere, anytime. Once logged in, they are provided with a multi-stage multi-step framework for developing the BPS DSET(s). Additional options within the software application may include searching for DSETs from other enterprises relating to best practices (e.g. COBIT for an in-house IT support service) or policy requirements (e.g. compliance with tax regulations) as well as others relating to dashboard generation, report generation, and financial tracking. In the planning and management method scoping stage, planners are offered a computer implemented bulletin board-type discussion group and social media services generally where the type of business information desired from each stage is captured. To illustrate, say planners want to implement a job creation program using the balanced scorecard method on a Microsoft Dynamics CRM system. They may wish to specify a type of information required as a table with name “Team Members”, having two columns, each having criteria for both populating it and validating it, such as each member's entry in their organization's Microsoft Active Directory (uSoftAD), e.g. Joe Smith, joe.smith@servicebook.ca, and their role, e.g. Manager—Pacific Call Centre Operations, uSoftAD being how Microsoft software provides and controls access of users to the software, and which typically as a minimum is their username and their password.

For each subsequent stage, the business information is either captured from planners, or retrieved by searching existing DSET(s) and then discussed with traceability of discussions and consensus/agreement/dissent. Again, planners are offered a software application based bulletin board-type discussion group where the information itself can be discussed and agreed upon. At each of the subsequent stages of the framework, different grids are provided automatically to the planners for completion based on the previously agreed results of other stages including the scoping phase. These grids are designed to capture the contributions of planners through the planning process, and the results may be used in discussions in other subsequent stages of the framework. In this way, throughout all stages, planners achieve consensus on elements of the DSET(s) for the initiative but importantly where questions arise as to interpretation/meaning are able to backtrack through the framework to establish the original intent and the contributions of participants that led to the determination of an element. Such a feature is beneficial where subsequent steps within a framework are completed with a team of planners that has an evolving membership as the steps in the process proceed. For example, a Chief Executive Officer may engage effectively in the first step(s) of capturing the Board of Director's vision for improving profitability but have minimal engagement in subsequent more detail orientated steps of the framework.

Once a DSET is complete and the Servicebook™ is agreed upon, a software application of the method enables planners to prepare BPS and performance profiles for the Servicebook™ in a way that can be searched by others. To illustrate with the aforementioned job creation program, planners may create an initiative profile called “Retail Job Creation Program” with keywords “Retail”, “Job Creation” and “Economic Development” and an initiative performance profile called “Retail Job Creation Program” with keywords “ISO9001 Certified”, “Small Enterprise”, “1,000 full-time jobs”, “Pacific North West”, and “3 months”. In this way, other planners may then query such profiles for various business planning purposes such as for example a retailer seeking to expand from their current geographic region of California into the Pacific North West states of Washington and Oregon and wanting to benefit from economic development programs that may be available.

Referring to FIG. 1, a framework 100 is depicted for preparing DSET(s) by considering a BPS implementation to occur through the phases of Strategies 110, Tactics 120 and Deployment 130 and is then considered for multiple hierarchies of planners as having roles of Management 140, Personnel 150, and Information Systems Professionals 160. The framework therefore allows for the capturing and validating of DSET elements from each role pertaining to each phase as they pertain to the BPS. It would be evident that according to the structure(s) of the organization(s) working on the framework 100 that the same individual may fulfill multiple roles as well as different individuals fulfilling each role.

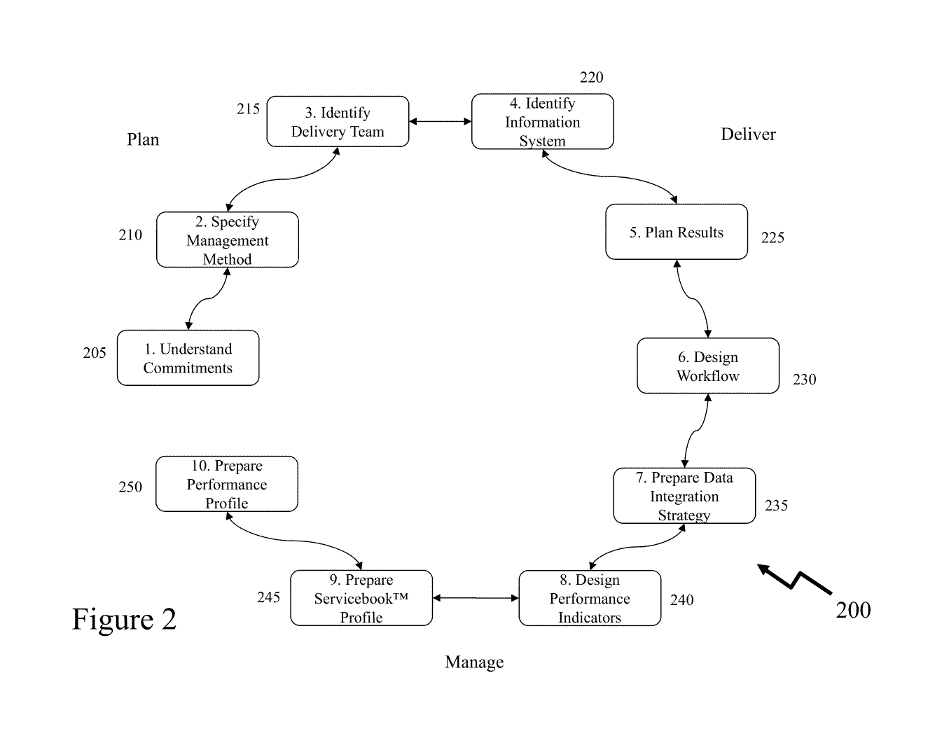

Now referring to FIG. 2 there is depicted an exemplary conceptualization 200 of the framework 100 of FIG. 1 specifying the stages of the framework for personnel to prepare a cohesive and complete DSET in consideration of each stage. Exemplary conceptualization 200 according to this embodiment of the invention represents one viewed from the role of those personnel receiving management directives and being responsible for delivering the BPS. Exemplary conceptualization 200 should therefore establish SMART (Specific, Measurable, Attainable, Relevant, Timely) DSET elements that are in a format suited to deployment on the enterprise's information systems, or the information systems of the multiple organizations in the case of a partnership.

As depicted exemplary conceptualization 200 comprises 10 steps in a three-phase Plan, Deliver, and Manage Servicebook™ implementation project in accordance with the framework, these 10 steps being:

1. Understand commitments 205;

2. Specify management method 210;

3. Identify delivery team 215;

4. Identity information system 220;

5. Plan results 225;

6. Design workflow 230;

7. Prepare integration strategy 235;

8. Design performance indicators 240;

9. Prepare Servicebook™ profile 245; and

10. Prepare performance profile 250.

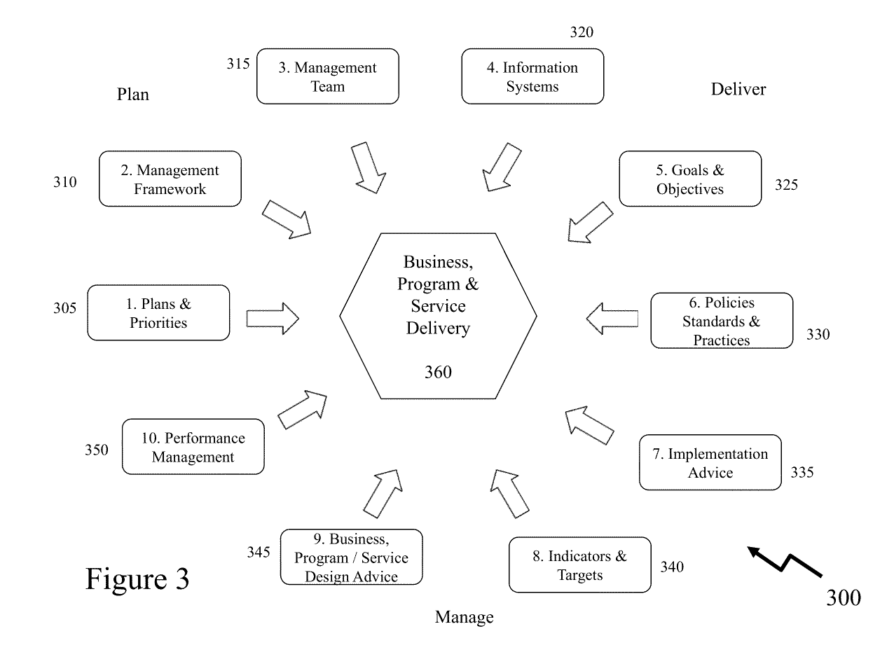

Referring to FIG. 3 there is depicted an exemplary conceptualization 300 of the framework 100 of FIG. 1 specifying the steps of the framework as discussions for providing guidance to personnel. Exemplary conceptualization 300 according to this embodiment of the invention represents one viewed from the role of managers who provide directives to those responsible for personnel implementing a BPS. Exemplary conceptualization 300 therefore in conjunction with exemplary conceptualization 200 as described above in respect of FIG. 2 would therefore establish SMART (Specific, Measurable, Attainable, Relevant, Timely) DSET(s) that are in a format suited to deployment to enterprises' information systems.

As depicted exemplary conceptualization 300 it comprises 10 steps which address the three phases of plan, deliver, and manage and feed the overall Business, Program & Service Delivery 360, these steps being:

1. Plans & Priorities 305;

2. Management Framework 310;

3. Management Team 315;

4. Information Systems 320;

5. Goals & Objectives 325;

6. Policies, Standards & Practices 330;

7. Implementation Advice 335;

8. Indicators & Targets 340;

9. Business, Program/Service Design Advice 345; and

10. Performance Management 350.

Accordingly, it is evident that exemplary conceptualization 300 indicates how managers who are providing directives to those responsible for implementing a program or service may provide initial and/or supporting information as well as direction and implementation data. With reference to the exemplary conceptualizations 200 and 300 in FIGS. 2 and 3 steps 1 to 8 of the framework are designed to capture BPS information pertaining to DSET(s) within scope for the Servicebook™ development project. By capturing and processing the business information in this way, embodiments of the invention provide a framework for establishing a complete set of dashboard system configuration parameters including the information required to deploy them on the information systems that will be used to deliver the business, program or service. Steps 9 and 10 of the framework are primarily intended for organization personnel to capture Servicebook™ and Servicebook™ performance profiles pertaining to the DSET in a way that can be searched by others.

Referring to FIG. 3, the information required of managers by personnel for each of the 10 steps is identified within the exemplary conceptualization 300. For example, personnel's Step 1 “Understand Commitments” requires that managers provide personnel with management's Step 1 “Plans and Priorities” whilst personnel's Step 6 “Design Workflows” requires that managers provide personnel with Management's Step 6 “Policies, Standards and Practices”. It would be evident to one skilled in the art that providing information from managers to personnel within a SSSA according to embodiments of the invention may be providing access to predetermined portions of the framework and/or discussion bulletin-board(s) or other social media. Within other embodiments of the invention this accessibility may be password protected to specific personnel or may be provided in a restricted and/or converted manner according to credentials (e.g. role, stage, position) so that aspects of the discussions are protected from general availability to all personnel but that the salient information is accessible. Where clarification as to an element or elements is required one or more users may provide the clarification directly or may allow temporary restricted access to predetermined personnel to allow the intent to be established with increased clarity.

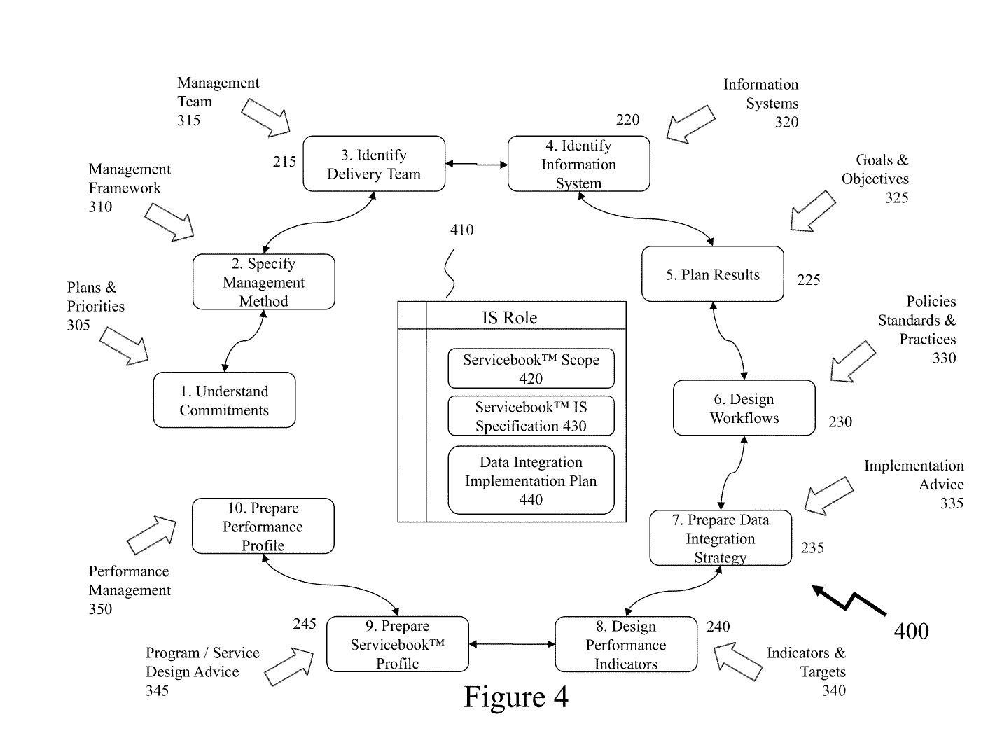

Now referring to FIG. 4 there is depicted an exemplary conceptualization 400 of the previous frameworks specifying the aligned steps of the frameworks 200 and 300 as viewed from the viewpoint of the Information Services personnel (sometimes referred to as Information Technology Professionals, Management Information Systems Department employees and other like terms) deploying the DSET and indicating the information required of managers and personnel in order for the IS Personnel to provision the information systems required to deploy the DSET.

This information allows the IS personnel to determine for the BPS the scope of the Servicebook™ being deployed within the Servicebook™ implementation project and which EIS have been chosen to support BPS data acquisition, analysis and reporting. As depicted this becomes Servicebook™ Scope 420 within IS Role 410. Secondly, arising from exemplary conceptualization 400 IS Professionals may determine the specifications for the Information Systems (IS) where the Servicebook™ is to be deployed, for example as determined in Step 4 Information System Identification (steps 220 and 320 within exemplary conceptualizations 200 and 300 respectively). This specification being depicted within exemplary conceptualization 400 as Servicebook™ IS Specification 430. Thirdly, exemplary conceptualization 400 provides for the IS Professionals to determine the data integration and interoperability implementation plan as determined in Step 7 in the instance that the deployment of the DSET is coincident with the migration of EIS to a new platform.

It would be evident to one skilled in the art that Servicebook™ as a SSSA together with the Servicebook™ method and implemented in a modular fashion through Servicebook™ implementation projects may serve many purposes. For example a Servicebook™ and the associated DSET may relate to assisting in performing one or more of the stages of a business reengineering or business transformation initiative. Alternatively, the purpose may be for planning all or a predetermined portion of the elements of a new program or service, for preparing all or a predetermined portion of the parameters required for configuring the information systems required to deliver a business, program or service, or for managing a mandate provided by one organization to one or more other organizations allowing the new mandate to be integrated into the activities of all partner organizations with their engagement from the initial concept planning through to the implementation. It would be further evident that a Servicebook™ and its DSET may form a predetermined portion of a portfolio of Servicebooks™ and their associated DSETs which are interlinked. For example, using the scenario described supra wherein a Servicebook™ generated by the U.S. Department of Labor relating to increasing the percentage of Government funding spent with small and minority businesses may be generated in conjunction with planners from the U.S. Bureau of Labor Statistics together with FedBizOpps, HUBZone, and US Commercial service. The resulting DSET of the generated Servicebook™ for U.S. Department of Labor linking to the DSETs of the U.S. Bureau of Labor Statistics, FedBizOpps, HUBZone, and US Commercial service supports a government-wide Servicebook™ of relevance to the Government Performance and Results Act requiring Preparation and Submission of Strategic Plans, Annual Performance Plans, and Annual Program Performance Reports in priority policy areas. Similarly, each of the Servicebooks™ for of the U.S. Bureau of Labor Statistics, FedBizOpps, HUBZone, and US Commercial service may link to the Servicebook™ for U.S. Department of Labor.

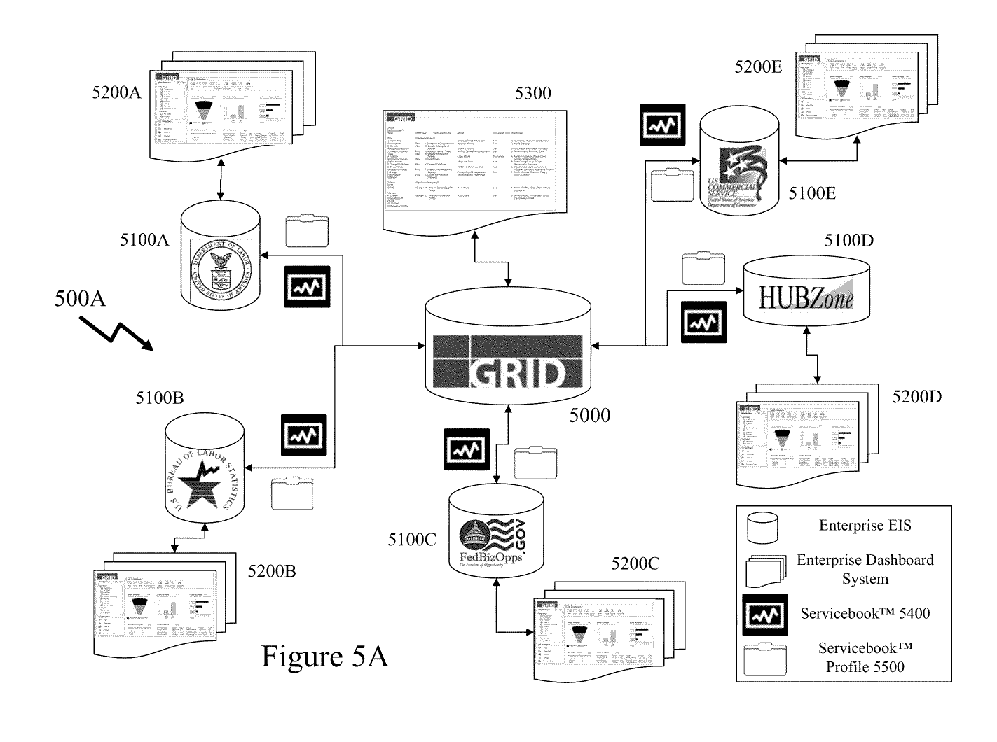

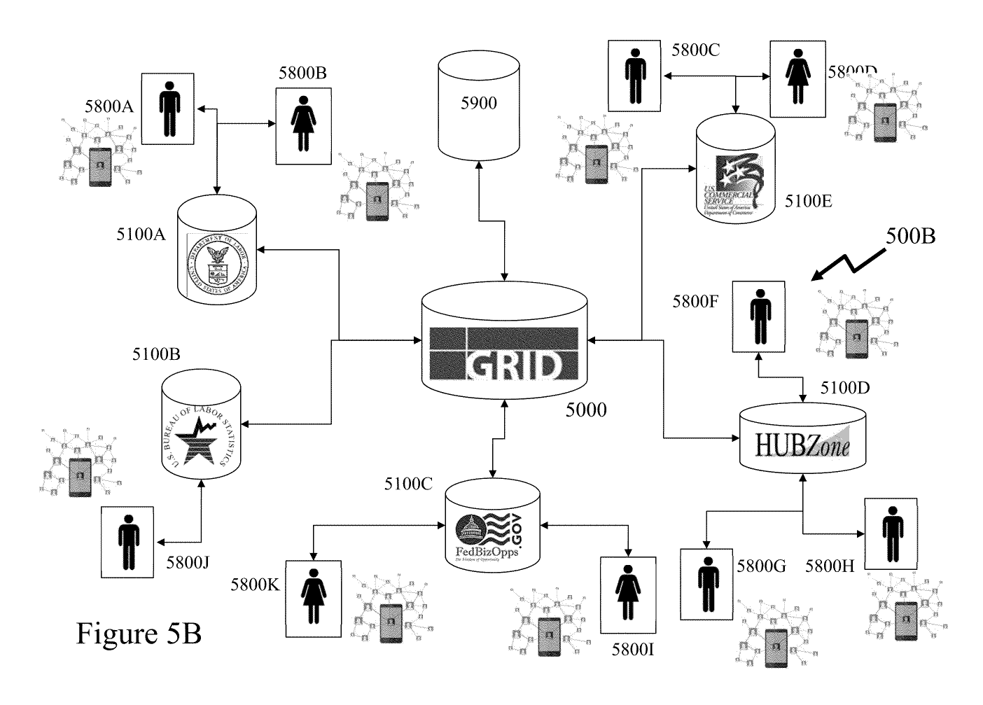

Referring to FIG. 5A there is depicted an exemplary simplified diagram of a collaborative program 500A using multiple Servicebooks™ and DSETs for such a scenario. Accordingly, there is depicted a central server 5000 having in execution upon it a software application according to an embodiment of the invention for Servicebook™ wherein the central server 5000 has a central Servicebook™ repository 5300 which is linked to first to fifth servers 5100A through 5100E respectively associated with the U.S. Department of Labor, U.S. Bureau of Labor Statistics, FedBizOpps, HUBZone, and US Commercial respectively. Locally stored upon each of first to fifth servers 5100A through 5100E respectively are first to fifth associated DSETs 5200A through 5200E respectively for each organization relating to specific implementation aspects of the overall Servicebook™ profile. Exchanged between central Servicebook™ 5300 and first to fifth associated DSETs 5200A through 5200E are data relating to the BPS implementation such that each of the organizations may employ their own internal IS systems etc. but the overall progress of the BPS and associated Servicebook™ is easily accessed and provisioned according to the agreements reached through the discussions and social media generally.

Optionally, each of first to fifth associated Servicebook™ profiles 5200A through 5200E may mirror content of the other associated DSETs such that each organization can see progress relating to the other partner organizations as well as the overall progress of all organizations together. Within FIG. 5A the transfer of data is represented by Servicebook™ 5400 on each link between the central server 5000 and the first to fifth servers 5100A through 5100E respectively whilst links transferring DSETs by Servicebook™ Profile 5500.

It would be evident that Servicebook™ and Servicebook™ performance profiles may serve many purposes including, but not limited to, the following:

for assisting stakeholders in the planning, delivery and management of businesses, programs and services for the achievement of business visions, missions and mandates;

for investors and program funders to become aware of the designs and models of various businesses, programs and services and their performance to inform investment decisions and policy making;

to review the discussion that led to the design of a program's or service's Servicebook™ for the purpose of identifying best practices or lessons learned;

to acquire, for example through purchase, a Servicebook™ for the purpose of configuring another enterprise's information systems that would be used to deliver a similar business, program or service;

to conduct analyses of multiple Servicebooks™ for the purpose of identifying gaps (e.g. competitor analyses) in businesses, programs and services for a particular clientele or market segment or other business-related analyses (e.g. scenario planning using game theory);

to conduct analyses of multiple Servicebooks™ for the purpose of identifying governance and management or other shortcomings in the planning, delivery and management of BPS, for example planned results for which there is no individual responsible;

for facilitating the understanding of the Servicebook™ of a BPS, for example by a prospective client using data visualization techniques;

for identifying enterprises with Servicebooks™ that would benefit from a product or service (e.g. advertising campaign design) or that may be affected by a political, economic, social or technological development (e.g. regulatory changes).

To facilitate communications between the participants in the business planning process and capture the results of the decision making process, a multiple discussion board or bulletin board system or social media services generally are provided. Participants can login to a portal, e.g. a web interface, and select the discussion board system based on the step of the planning process they are at, and post their position on each element in their purview of the DSET. The user, or the moderator, or another party, may also pre-populate the discussion board or grids from an existing Servicebooks™ that they may have accessed through searching the Servicebook™ SSSA or which they may have otherwise obtained. Such discussion/bulletin boards/grids may have been created by other groups within their own organization, by standards organizations, or by organizations they may want to partner with or compete with. The effect of such pre-populating of the boards may establish DSET (e.g. KPI) that should be agreed upon, impose or suggest validation criteria for those elements, impose or suggest subsequent information gathering or processing requirements, or introduce information gathering or processing steps or tasks or sequences of tasks for those elements or any other input that may be captured and/or stored in a discussion board or social media generally, including by appending media to posts, or in an audit trail for posts to a discussion/grid.

Discussion participants can edit their own, or respond to previous, postings, thereby creating a clear audit trail on who contributed what elements of each DSET. A participant with moderator credentials can guide the discussion as well as ensure that a focus for the discussion is maintained. New participants may be invited, such as subject matter experts and partners, and others removed, for example when a final decision is to be made. Once a decision is made regarding a DSET, or a profile or element thereof, the agreed upon element or elements are marked as approved for the next step in the framework.

Referring to the bottom of FIG. 1, the Servicebook™ development process concludes when participants in each role have specified specific elements, including, but not limited to, the following:

the elements of the DSET in a format that is suited to configure the enterprise's information systems so that they would then be able to be used to deliver programs and services and generate dashboards in accordance with the DSET requirements;

the DSET is deployed and performance records are being accumulated in the information systems; and

the profiles of Servicebook™ and the associated performance records are prepared in a format that is suited to searching by others for their use for various business planning and other related purposes.

Referring to FIG. 5B there is illustrated a block diagram of a system 500B for the discussion group system according an embodiment of the invention which overlays to the collaborative program 500A described above in respect of FIG. 5A. The system 500B therefore contains the central server 5000 together with the first to fifth servers 5100A through 5100E respectively. Connected to central server 5000 is a discussion board server 5900 which supports those software elements of the SSSA for Servicebook™ relating to the discussion board. Logged into the discussion board server 5900 are first to ninth participants 5800A through 5800J respectively. As depicted these participants are shown connected to the discussion board server 5900 via the first to fifth servers 5100A through 5100E respectively indicating that the participants are accessing the Servicebook™ through the infrastructure of their respective organizations. However, it would be evident that due to the web interface and nature of the Internet that the participants may be accessing the Servicebook™ and discussion board server 5900 through separate communication channels. Tenth participant 5800K represents the moderator for the discussion who may steer/direct the discussion using predetermined guidelines and/or guides and/or online tools for validating DSETs.

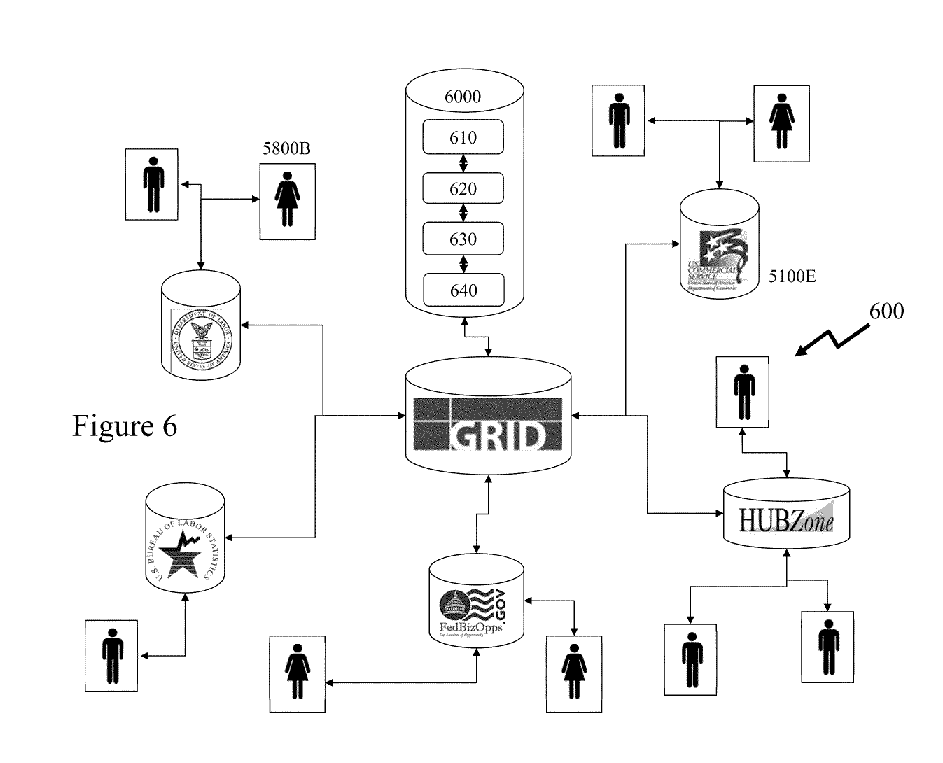

It should be noted that the discussion group system noted above and which is used by participants to determine and decide on the entries in the various grids can be integrated. Referring to FIG. 6 such a system 600 is depicted wherein the discussion board server 5900 is depicted as discussion board storage facility 6000 comprising a discussion group module 610, a login module 620, and a storage module 630. Accordingly, users (participants) log in to the discussion board storage facility 6000 using the login module 620 and, based on their login, users are given access to their enterprise's discussion group via the discussion group module 610 and/or their enterprise's discussion storage area within storage module 630. Module 640 depicts the data integration and system interoperability engine (e.g. Informatica, Mulesoft) for ensuring changes to the Servicebook™ and associated DSETs are deployed into operational settings as agreed by planners. Each enterprise which has an account with the Servicebook™ SSSA can be provided with a discussion board into which their participants enter the discussions with, as noted above, a suitable moderator.

Each enterprise can also be provided with a private storage area using the storage module 630 or the entire invention may be replicated behind an enterprise's firewall. The resulting grids for each enterprise can be stored in this storage area where they can be accessed by participants from that enterprise. It would therefore be evident that where enterprises seek to collaborate on a specific initiative/mandate that predetermined participants may be granted login rights that allow them to access grids or predetermined portions of grids for that initiative/mandate for another one or predetermined subset of the partnering enterprises. Accordingly, enterprises can determine if there is a basis for cooperation on the initiative in some instances as well as use the discussion boards for capturing the discussions/consensus with regard to the DSETs for the collaborative Servicebook™. For ease of access the Servicebook™ SSSA can be web-enabled so that participants access it using a regular web browser from anywhere/any device or alternatively, to address potential security issues, a dedicated platform may be required to access the system. Such dedicated platform may be device specific for a particular user, such as for example not only must login credentials match a user of the Servicebook™ SSSA but also be received from the correct Internet Protocol address of the computer being used by the user. It would also be evident that the system may be implemented as a single server hosting both the storage area modules and the discussion group modules for the various enterprises registered with the system or alternatively it may be implemented as multiple servers. It should be noted that while the above description mentions a moderator for the discussion groups, such a moderator is not strictly necessary, for example for an enterprise operating under a franchise model to deploy a DSET to its franchisees, but may accelerate the process.

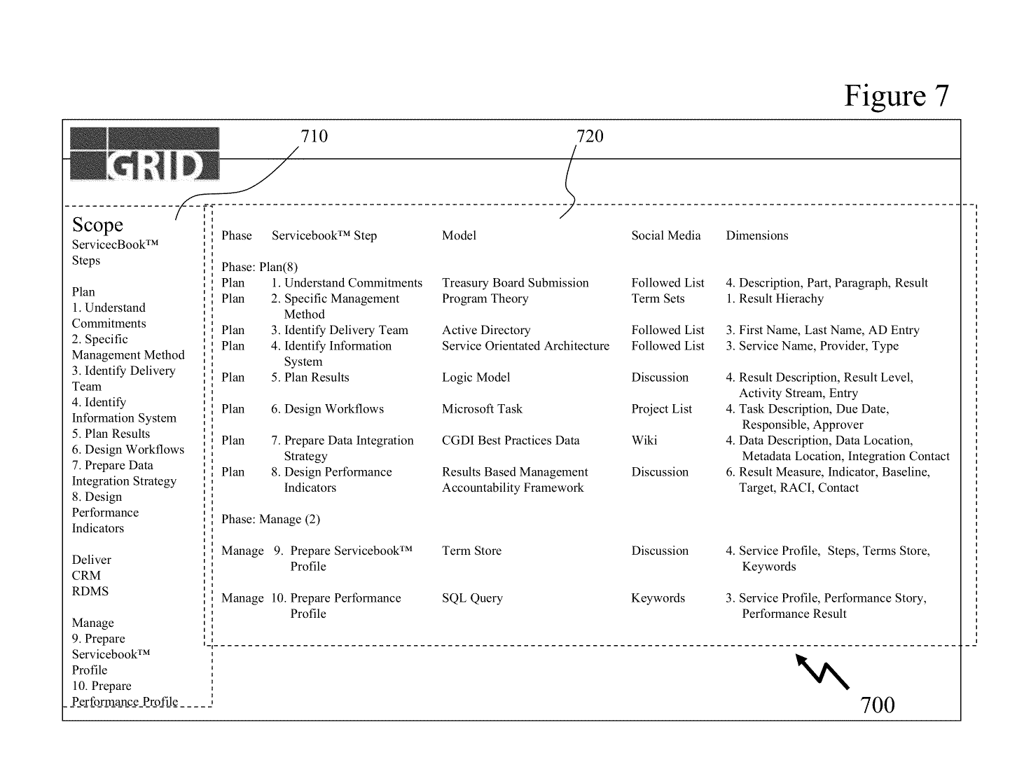

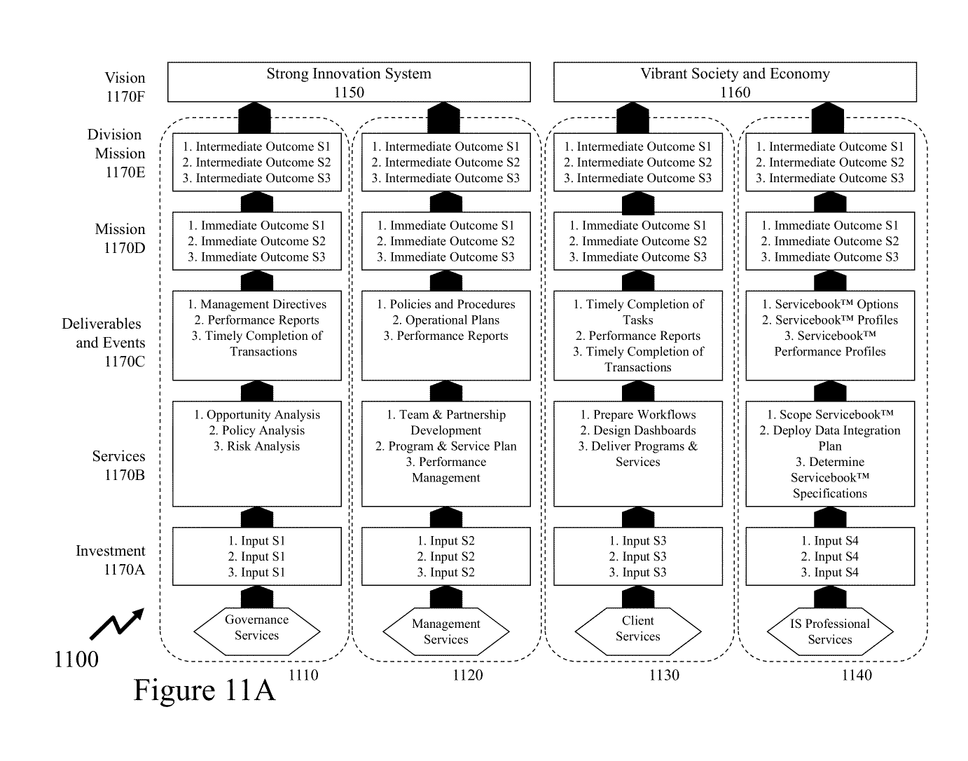

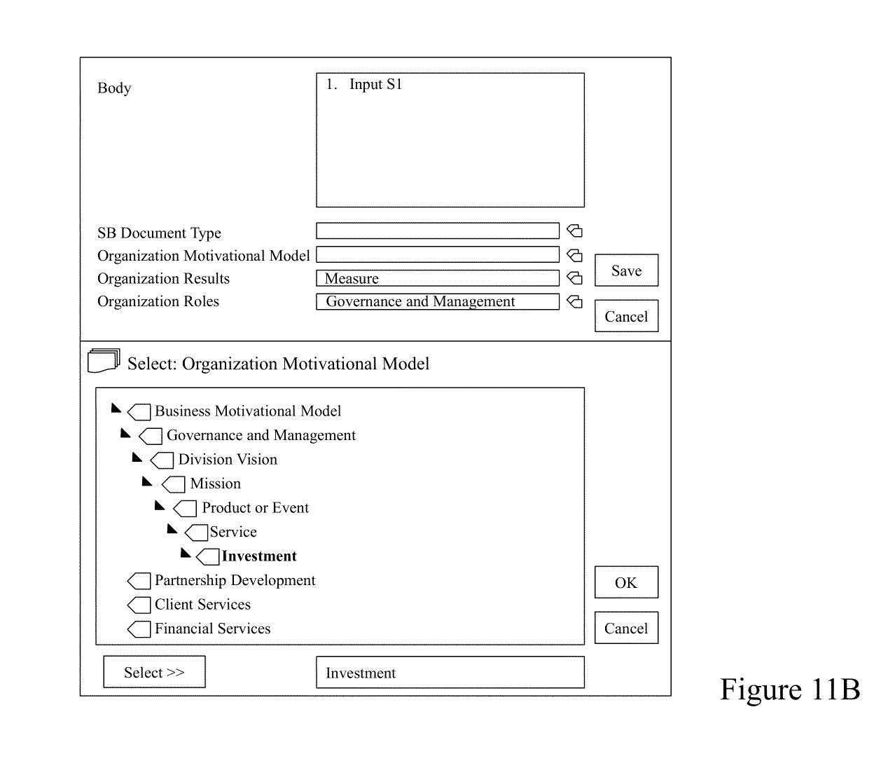

Referring to FIG. 7, there is depicted an exemplary Servicebook™ grid 700 arising from the result of discussions at Planning and Management Method Step 0 Scope of the Framework within a Servicebook™. As evident from the figure, this Step presents exemplary information detailing the types of business information that planners have agreed upon for the purpose of planning, delivering and managing their BPS. Accordingly the Servicebook™ grid 700 comprises a menu portion 710 and Servicebook™ specific portion 720. As such the Step 0 seeks to inventory desired elements that will inform the DSET such as planned results from plans and priorities (e.g. business plans) to deliver programs and services and then, through structured information management techniques, tools and workflows generally available on web portal and content management applications, enable users to define the subsequent steps of the Servicebook™ method. As depicted Servicebook™ specific portion 720 presents the Servicebook™ steps and phases, the model for each step/phase chosen, the format of the social media used to prepare the grids, and the dimensions currently established for those grids. For example Step 2 “Specify Management Method” is associated with an Active Directory model whereas Step 5 “Plan Results” is associated with a logic model, a model common to programs and services using program theory as a management method. As depicted in the Figure, “Specific Management Method” is associated with a dimension “1” being the “Result Hierarchy” whilst “Plan Results” is of dimension “4” comprising a Result Description, Result Level, Activity Stream, and Entry which are required to present a result hierarchy in logic model format as later depicted in FIG. 11A and populated according to the screen in FIG. 11B.

Accordingly, the Servicebook™ SSSA and method allows for:

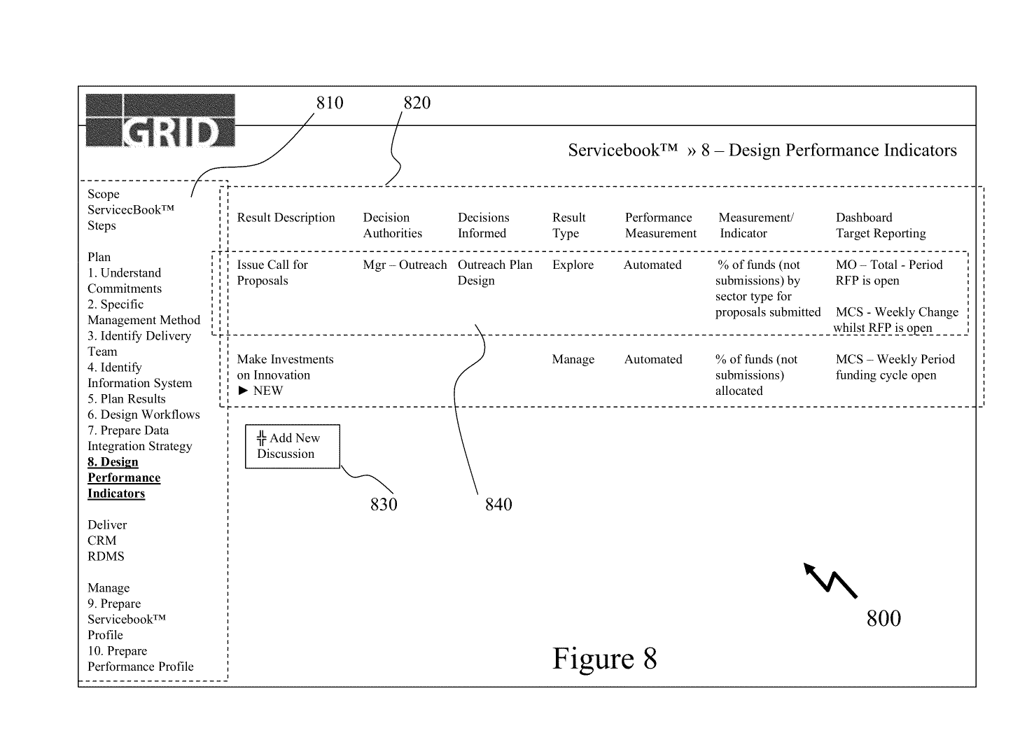

the definition of a multistage process creating the DSET for the planned results in a manner that facilitates or enables its deployment in a workflow and/or Client Relationship Management (CRM) system, Enterprise Resource Planning (ERP) system or other enterprise information system or systems (EIS), such as discussed below in respect of FIG. 8;

compile this information in a storage facility for the Servicebook™ software application and/or software system;

configure automatically or semi-automatically this information into the EIS which personnel will use to deliver the BPS;

enable the automatic or semi-automatic generation of dashboards, performance reports, or other decision support information and/or tools for BPS managers and personnel to make evidence-based decisions to achieve business goals in accordance with business strategies, plans and priorities; and

enable the archiving of DSETs and performance information for managers, personnel, auditors, evaluators and other internal and external stakeholders to search past performance according to the performance indicators enabled by the DSETs.

Now referring to FIG. 8 there is depicted an exemplary Servicebook™ grid 800 arising from the result of discussions at Step 8 Design Performance Indicators including menu 810 wherein the grid being depicted is indicated within the overall Servicebook™ sequence. Accordingly, these discussion summaries are presented in grid element 820 along with a button 830 allowing a participant to add a new discussion. As depicted discussion 840 relates to a result description “Issue Call for Proposals” wherein the result measurement method is established as the percentage of funds by sector type for proposals submitted. Importantly this method includes the clarification that the percentage not be calculated based on the number of submissions received which some might misinterpret. If this was not specified and there was a subsequent query then the dashboard generated from this DSET relating to this element would be incorrect and the genesis of the misinterpretation could be accessed and the participant decision process/discussion thread reviewed for clarification. Various other elements of the performance indicator are illustrated, for example the users have indicated the decisions to be informed by the indicator values on the dashboard, in this case if the response to the Call for Proposals does not generate proposals from the targeted sectors the Outreach Plan will be revised to promote the Call in the appropriate sectors.

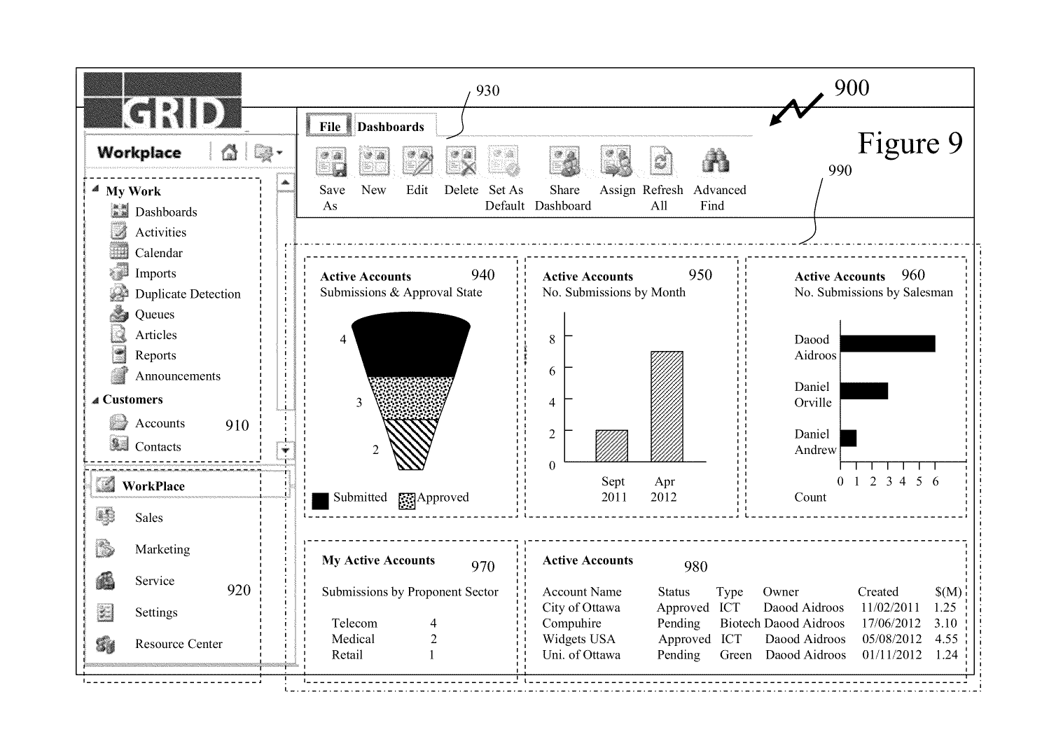

Now referring to FIG. 9 there is depicted a dashboard 900 of a client relationship management (CRM) system according to an embodiment of the invention. Dashboard 900 has been configured with the DSET, and then used to receive submissions in response to a Call for Proposals, the status of which are displayed in the dashboard according to the DSET parameters according to the user credentials accessing the CRM. Accordingly, dashboard 900 comprises a first menu 910 presenting options to the user relating to their personal workspace within the CRM system as well as a second menu 920 presenting options relating to the enterprise within the CRM system. As the user has selected “Dashboard” in first menu 910 then the main portion of the screen depicts a toolbar 930 relating to dashboards and personal dashboard 990 comprising a “sales funnel” Active Accounts 940, “submissions chart” Active Accounts 950, and “sales person progress” Active Accounts 960, “proponent sector” Active Accounts 970, and “tabulated” Active Accounts 980.

After the process illustrated in FIG. 4 has been executed, the desired end result in this example is a reconfiguration of the enterprise's CRM or any equivalent system that the enterprise may have to implement the BPS. This reconfiguration would result in dashboards (or whatever user interface the enterprise's system may have) that track the performance indicators that were determined while traversing the multi-stage framework. These dashboards are then provided to the relevant personnel at the enterprise according to what was agreed to for them as the framework was traversed so that they may track progress in alignment with how others are also tracking progress on different dashboards configured from the same or aligned DSETs.

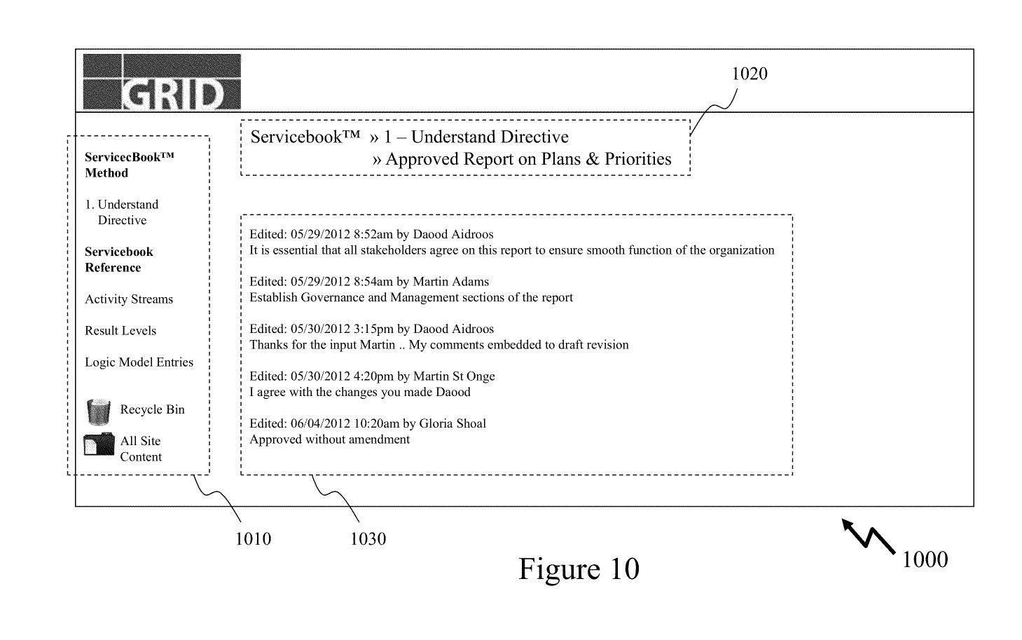

Now referring to FIG. 10 there is depicted an exemplary audit trail 1000 presented to a user for approved discussion board entries according to an embodiment of the invention. The audit trail 1000 relating to Stage 1—Understand Directive and associated sub-task Approved Report on Plans & Priorities. The aspect of the Servicebook™ audit trail being depicted is identified by header 1020 and within menu 1010 to the user whilst trail 1030 provides the audit trail entries from the different users.

Within the preceding descriptions in respect of FIGS. 1 through 10 the Servicebook™ SSSA and or method have been described. Referring to FIG. 11A there is depicted an exemplary Servicebook™ Activity-Result model 1100 according to an embodiment of the invention as described in FIG. 7 where a Result Hierarchy was specified. As depicted first to fourth activity streams 1110 through 1140 representing “Governance”, “Management”, “Client”, and “IS Professional” services respectively. First and second activities 1110 and 1120 being determined through the framework as planned to achieve the result of a Strong Innovation System 1150 and third and fourth activities 1130 and 1140 serving to create a Vibrant Society and Economy 1160. Each of the first to fourth activities 1110 through 1140 comprises first to sixth levels of the result hierarchy 1170A through 1170F respectively which are identified as Investment, Services, Deliverables and Events, Mission, Division Mission and Vision such as can be found in some Business Motivational Models. In this example, the planners have completed modules of the framework but other elements are to be prepared by other planners—this is often the case when 1170C Deliverables of multiple partners (e.g. each contributing sub-assemblies required by another partner) but they may achieve immediate outcome (e.g. to be paid for those assemblies) when their common client accepts as input 1170A the last of those assemblies.

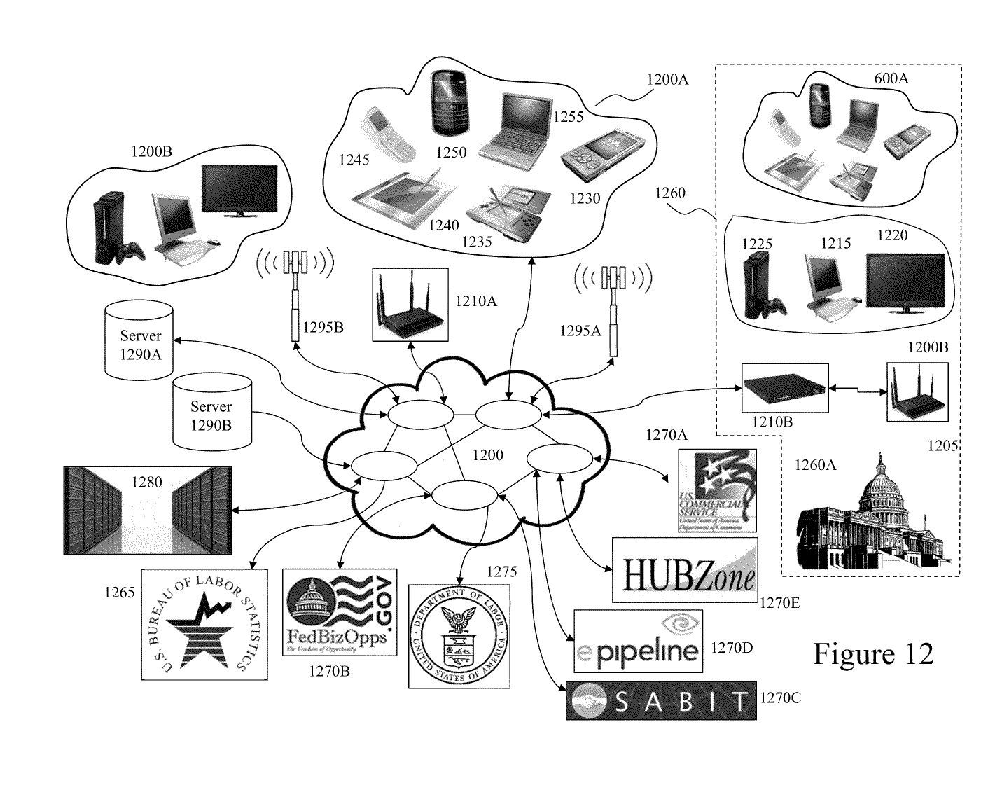

Referring to FIG. 12 there is depicted an exemplary information management lens viewpoint of a Servicebook™ according to an embodiment of the invention. As depicted the upper half (A) of FIG. 12 depicts a method according to an embodiment of the invention comprising two strands whilst the lower half (B). Within first strand a Management Method Profile 1210 results in Management Method Grid 1220 which generates Result Grid 1230 and therein Workflow Grid 1240. The second strand begins with Delivery Profile 1250 that results in Delivery Grid 1260 and therefrom PSIS Grid 1270. Within the lower half (B) it can be seen that between Management Method Profile 1210 and Management Method Grid 1220 a first Servicebook™ grid 1290A is pre-loaded providing the basis for planner entry by the participants.

Similarly, between Delivery Profile 1250 and Delivery Grid 1260 a second Servicebook™ grid 1290B is pre-loaded providing the basis for planner entry by the participants. Finally, between Management Method Grid 1220 and Result Grid 1230 a Servicebook™ 1290C is preloaded. Accordingly, it would be evident to one skilled in the art that as the process executes one or more grids and at least one Servicebook™ are loaded thereby guiding the participants through the completion of that stage and to the next. Accordingly, one result of the multi-stage framework from the Servicebook™ SSSA is the automatic generation of a configuration file for the enterprise's selected CRM to host the Servicebook™ implementing the organization's mandate and BPS(s) as well as providing the interface through which the DSET(s) are reported through the user dashboards which are prepared by the CRM and/or an associated MIS. This Servicebook™ configuration file would detail not just the performance indicators previously determined by the participants of the discussion groups, but also who is responsible for these performance indicators. Further, the Servicebook™ configuration file would detail which fields, forms, and data points need to be tracked using the enterprises CRM/EIS system. Accordingly, the Servicebook™ configuration file can therefore be used to reconfigure the enterprise's CRM/EIS for the tracking of these indicators. This reconfiguration may be done automatically or the configuration file may be used as a guideline for programmers and system administrators to reconfigure the enterprise's manual or other information systems.

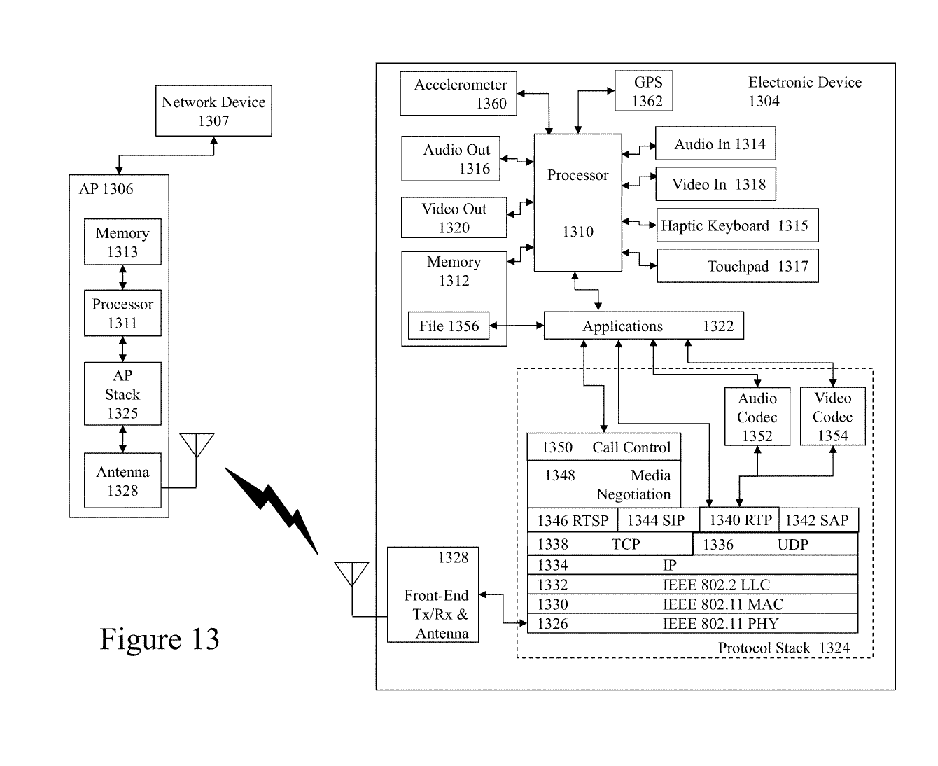

Now referring to FIG. 13 there is depicted a network 1300 supporting communications to and from electronic devices implementing contextual based UIs according to embodiments of the invention. As shown first and second user groups 1300A and 1300B respectively interface to a telecommunications network 1300. Within the representative telecommunication architecture a remote central exchange 1380 communicates with the remainder of a telecommunication service providers network via the network 1300 which may include for example long-haul OC-48/OC-192 backbone elements, an OC-48 wide area network (WAN), a Passive Optical Network, and a Wireless Link. The central exchange 1380 is connected via the network 1300 to local, regional, and international exchanges (not shown for clarity) and therein through network 1300 to first and second wireless access points (AP) 1395A and 1395B respectively which provide Wi-Fi cells for first and second user groups 1300A and 1300B respectively. Also connected to the network 1300 are first and second Wi-Fi nodes 1310A and 1310B, the latter of which being coupled to network 1300 via router 1305. Second Wi-Fi node 1310B is associated with sponsor 1360A, in this instance the US Government, and environment 1360 within which are first and second user groups 1300A and 1300B. Second user group 1300B may also be connected to the network 1300 via wired interfaces including, but not limited to, DSL, Dial-Up, DOCSIS, Ethernet, G.hn, ISDN, MoCA, PON, and Power line communication (PLC) which may or may not be routed through a router such as router 1305.

Within the cell associated with first AP 1310A the first group of users 1300A may employ a variety of portable electronic devices including for example, laptop computer 1355, portable gaming console 1335, tablet computer 1340, smartphone 1350, cellular telephone 1345 as well as portable multimedia player 1330. Within the cell associated with second AP 1310B are the second group of users 1300B which may employ a variety of fixed electronic devices including for example gaming console 1325, personal computer 1315 and wireless/Internet enabled television 1320 as well as cable modem 1305.

Also connected to the network 1300 are first and second APs which provide, for example, cellular GSM (Global System for Mobile Communications) telephony services as well as 3G and 4G evolved services with enhanced data transport support. Second AP 1395B provides coverage in the exemplary embodiment to first and second user groups 1300A and 1300B. Alternatively the first and second user groups 1300A and 1300B may be geographically disparate and access the network 1300 through multiple APs, not shown for clarity, distributed geographically by the network operator or operators. First AP 1395A as show provides coverage to first user group 1300A and environment 1360, which comprises second user group 1300B as well as first user group 1300A. Accordingly, the first and second user groups 1300A and 1300B may according to their particular communications interfaces communicate to the network 1300 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-2000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly portable electronic devices within first user group 1300A may form associations either through standards such as IEEE 802.15 and Bluetooth as well in an ad-hoc manner.

Also connected to the network 1300 are primary enterprise 1375, the U.S. Department of Labor, first partner enterprise 1375, the U.S. Bureau of Labor Statistics and second through fifth partner enterprises 1370A through 1370E respectively, being U.S. Commercial Service, FedBizOpps, Special American Business Internship Training (SABIT), epipeline, and HUBZone respectively. These together with first and second servers 1390A and 1390B, which together with others not shown for clarity, may host according to embodiments of the inventions multiple services associated with a provider of the software operating system(s) and/or software application(s) associated with the electronic device(s), a provider of the electronic device, provider of one or more aspects of wired and/or wireless communications, product databases, inventory management databases, retail pricing databases, license databases, customer databases, websites, and software applications for download to or access by fixed and portable electronic devices. First and second primary content sources 1390A and 1390B may also host for example other Internet services such as a search engine, financial services, third party applications and other Internet based services.

Accordingly, the primary enterprise 1375, first partner enterprise 1365, and second through fifth partner enterprises 1370A through 1370E respectively coupled to network 1300 allow for a Servicebook™ SSSA such as described above in respect to exemplary embodiments of the invention for providing an increase in small business revenue from the U.S. Government. It would be evident that in other embodiments of the invention only one enterprise may be present implementing a Servicebook™ whilst in others two or more may be implementing multiple BPS(s) with associated DSET(s) that are combined into a Servicebook™ of a parent enterprise establishing the mandate to partner organizations.

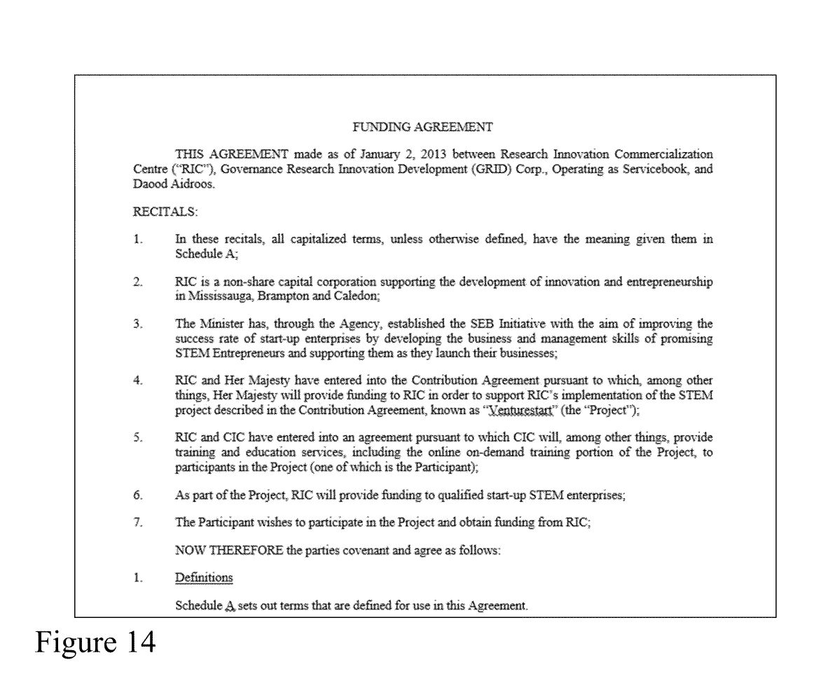

Within the embodiments of the invention described above in respect of FIGS. 1 through 13 participants, users, business planners etc. may access the Servicebook™ SSSA through either a PED or a FED, i.e. an electronic device. Referring to FIG. 14 there is depicted an electronic device 1404 and network access point 1407 supporting contextual based UIs according to embodiments of the invention. Electronic device 1404 may for example be a portable electronic device or a fixed electronic device and may include additional elements above and beyond those described and depicted. Also depicted within the electronic device 1404 is the protocol architecture as part of a simplified functional diagram of a system 1400 that includes an electronic device 1404, such as a smartphone 1355, an access point (AP) 1406, such as first AP 1310, and one or more network devices 1407, such as communication servers, streaming media servers, and routers for example such as first and second servers 1390A and 1390B respectively. Network devices 1407 may be coupled to AP 1406 via any combination of networks, wired, wireless and/or optical communication links such as discussed above in respect of FIG. 1. The electronic device 1404 includes one or more processors 1410 and a memory 1412 coupled to processor(s) 1410. AP 1406 also includes one or more processors 1411 and a memory 1413 coupled to processor(s) 1411. A non-exhaustive list of examples for any of processors 1410 and 1411 includes a central processing unit (CPU), a digital signal processor (DSP), a reduced instruction set computer (RISC), a complex instruction set computer (CISC) and the like. Furthermore, any of processors 1410 and 1411 may be part of application specific integrated circuits (ASICs) or may be a part of application specific standard products (ASSPs). A non-exhaustive list of examples for memories 1412 and 1413 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic device 1404 may include an audio input element 1414, for example a microphone, and an audio output element 1416, for example, a speaker, coupled to any of processors 1410. Electronic device 1404 may include a video input element 1418, for example, a video camera, and a video output element 1420, for example an LCD display, coupled to any of processors 1410. Electronic device 1404 also includes a keyboard 1415 and touchpad 1417 which may for example be a physical keyboard and touchpad allowing the user to enter content or select functions within one of more applications 1422. Alternatively the keyboard 1415 and touchpad 1417 may be predetermined regions of a touch sensitive element forming part of the display within the electronic device 1404. The one or more applications 1422 that are typically stored in memory 1412 and are executable by any combination of processors 1410. Electronic device 1404 also includes accelerometer 1460 providing three-dimensional motion input to the process 1410 and GPS 1462 which provides geographical location information to processor 1410.

Electronic device 1404 includes a protocol stack 1424 and AP 1406 includes a communication stack 1425. Within system 1400 protocol stack 1424 is shown as IEEE 802.11 protocol stack but alternatively may exploit other protocol stacks such as an Internet Engineering Task Force (IETF) multimedia protocol stack for example. Likewise AP stack 1425 exploits a protocol stack but is not expanded for clarity. Elements of protocol stack 1424 and AP stack 1425 may be implemented in any combination of software, firmware and/or hardware. Protocol stack 1424 includes an IEEE 802.11-compatible PHY module 1426 that is coupled to one or more Front-End Tx/Rx & Antenna 1428, an IEEE 802.11-compatible MAC module 1430 coupled to an IEEE 802.2-compatible LLC module 1432. Protocol stack 1424 includes a network layer IP module 1434, a transport layer User Datagram Protocol (UDP) module 1436 and a transport layer Transmission Control Protocol (TCP) module 1438.

Protocol stack 1424 also includes a session layer Real Time Transport Protocol (RTP) module 1440, a Session Announcement Protocol (SAP) module 1442, a Session Initiation Protocol (SIP) module 1444 and a Real Time Streaming Protocol (RTSP) module 1446. Protocol stack 1424 includes a presentation layer media negotiation module 1448, a call control module 1450, one or more audio codecs 1452 and one or more video codecs 1454. Applications 1422 may be able to create maintain and/or terminate communication sessions with any of devices 1407 by way of AP 1406. Typically, applications 1422 may activate any of the SAP, SIP, RTSP, media negotiation and call control modules for that purpose. Typically, information may propagate from the SAP, SIP, RTSP, media negotiation and call control modules to PHY module 1426 through TCP module 1438, IP module 1434, LLC module 1432 and MAC module 1430.

It would be apparent to one skilled in the art that elements of the electronic device 1404 may also be implemented within the AP 1406 including but not limited to one or more elements of the protocol stack 1424, including for example an IEEE 802.11-compatible PHY module, an IEEE 802.11-compatible MAC module, and an IEEE 802.2-compatible LLC module 1432. The AP 1406 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module.

Portable and fixed electronic devices represented by electronic device 1404 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-2000, DSL, Dial-Up, DOCSIS, Ethernet, G.hn, ISDN, MoCA, PON, and Power line communication (PLC).

The above presents methods and systems to provision social media services on content management and transaction processing systems using networks of devices for use by planners to in effect define the terms and conditions of their obligations (or their promise) under a BPS in terms of art common to those implementing the BPS, and such that the DSET generated according to those terms may be deployed to a machine so that as work begins to fulfill the promise, the machine informs the parties of the extent of fulfillment in accordance with the DSET.

The above also illustrates the importance of arriving at a common interpretation of specific terms of art for the planning and management method, such as “result hierarchy” and “logic model”, for the DSET to be machine interpretable.

While there is extensive prior art that speaks to promise fulfillment by preparing machine interpretable language, such as HTML5, for Enterprise Information System services that serve in fulfilling the promise, less prior art speaks to formulating the promise itself to be machine interpretable, particularly when the promise involves many parties each with numerous agents (e.g. Servicebook™ users) and who may not all speak the same language, be available at the same time, or in the same place. A key challenge for such parties is thus to arrive at common terms of art for the planning and management method that lead to DSETs that are machine interpretable as they implement a Servicebook™ project to PDM a BPS.

Thus a further method component of the invention serves each party to a promise to establish the correspondence of their terms of art in a promise to the terms of art of other parties for the purpose of arriving at a common understanding of the promise, its extent, and the DSET for monitoring the automated or semi-automated fulfillment of the promise over time using the agreed upon planning and management method.

A further systems component instantiating the further method component is a machine that receives a promise using both common and uncommon terms of art to users, and renders the these terms in a multimedia instrument via an HMI, such as a speech-to-text rendering of a recording of a promise between two CEOs to merge their companies. The system then provisions the parties with previously described discussion and social media services including online communities, chat and whisper rooms, training and guidance resources, decision support tools (e.g. survey forms, voting tools), markup tools including highlighters and comment boxes, co-browsing instruments, language parsers, linkers and loaders, translation and other tools such as whiteboards enabling many-to-many simultaneous communication, and expert help lines. The promisors, or their agents, then catalogue the uncommon terms (e.g. due to a poor recording, the voiced “timely delivery” may be rendered as text “timely del???”) into facets of each original term until a common term equivalent to the uncommon term has been agreed to by the promisors. So, for example, the progression of facets for five agents of the two CEOs for the uncommon term “timely del???” could be to be agreed to be “timely delivery” (with this acceptance say one party becomes observer, thereby deferring to the other four for establishing fulfillment conditions)->which becomes say [(actual date−promised date) is less than two weeks] (at this point say two more parties become observers thus delegating to the two remaining agents to finalize the promise)->which becomes say [(actual−promised date)<10 business days] (now say the final 2 agree, the common term of art for the two CEOs and their five agents is thus established from the promissory term ““timely del???” and this common term is then further faceted to arrive at conditions of fulfillment and consequent sanctions.

The unique mapping of an uncommon term to its conditions of fulfillment is called a facet chain, and such a chain is accepted when each party has specified their position on the facet chain. A promise is said to be accepted when all facets are accepted. A promise is said to be enacted when the resource allocation, including timing of receipt, of each party to each facet is a record of each party. A promise is said to be fulfilled when the machine has determined that all terms and conditions have been met or the machine is unable to enforce a sanction as anticipated. The method anticipates that parties may automatically delegate to an arbiter the determination of facets for terms and conditions. For example a financial brokerage may use the TSE 300 to benchmark broker performance and execute sanctions such as bonus amounts accordingly. And the arbiter may change over the promise lifecycle, for example based on the most “likes” in virtual legal community. To assist in minimizing impact of breach of trust on parties, for example due to unanticipated future events, the method and system offers the parties options to change the promise, for example by deferring to a credentialed physician agreed to by the parties to modify an agent's availability based on a health condition that would otherwise cause a breach in promise.

FIG. 14 provides an excerpt from a multi-party promise among a Regional Innovation Centre (RIC) to provision resources to a company to be identified and under the stewardship of a Local IC (LIC) for the purpose of the company developing and piloting a new product in a commercial setting under a government funded economic development program.

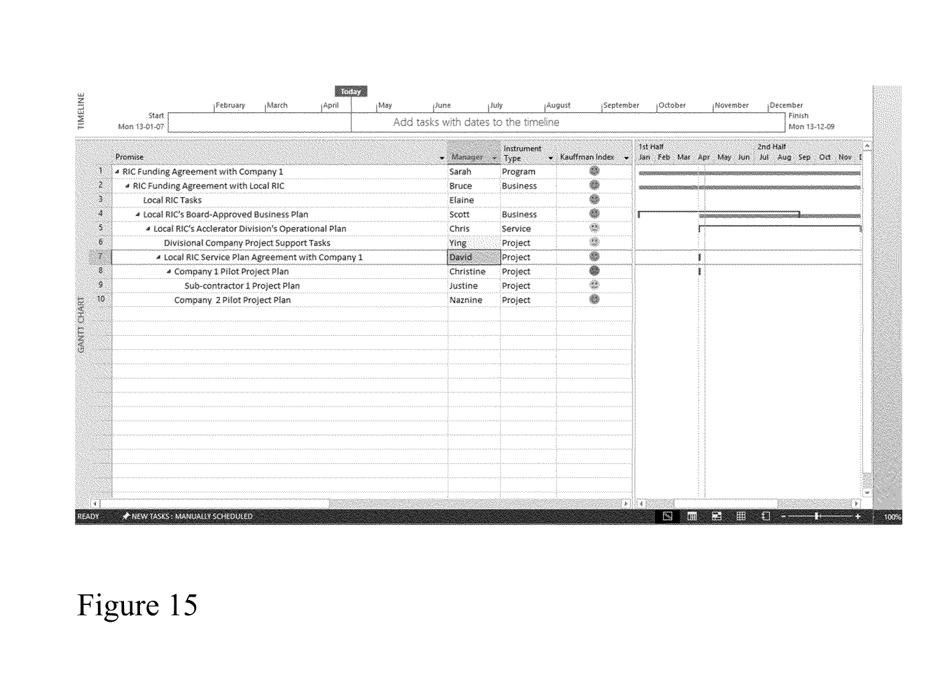

FIG. 15 presents in a simple embodiment of this aspect of the method and system providing the facet chain for the project to fulfill the promise in FIG. 14, that project being in the form of a mutually agreed upon common terms of art from the uncommon terms of the promise of FIG. 14 and recorded as a project work breakdown structure (WBS) facet chain with each party accepting the respective terms and tasks and measures and indicators and targets and sanctions of other parties, as well as a third party fulfillment indicator that assesses promise fulfillment and executes visual sanctions using green, yellow and red colored smiley icons. While the facets of planned cash flows and other financial indicators of each party pertaining to each task are not seen due to space constraints, the third party's indicator may be adjusted to automatically or semi-automatically implement financial sanctions based on financial and other indicators using pre-authorized access to escrow or other financial accounts as was agreed by the parties to the promise. Note that this view of the WBS is seen by a user with credentials to view all tasks at this level of the WBS, other users my see only their tasks under their preferred view such as through a calendar, workflow or otherwise formatted view.

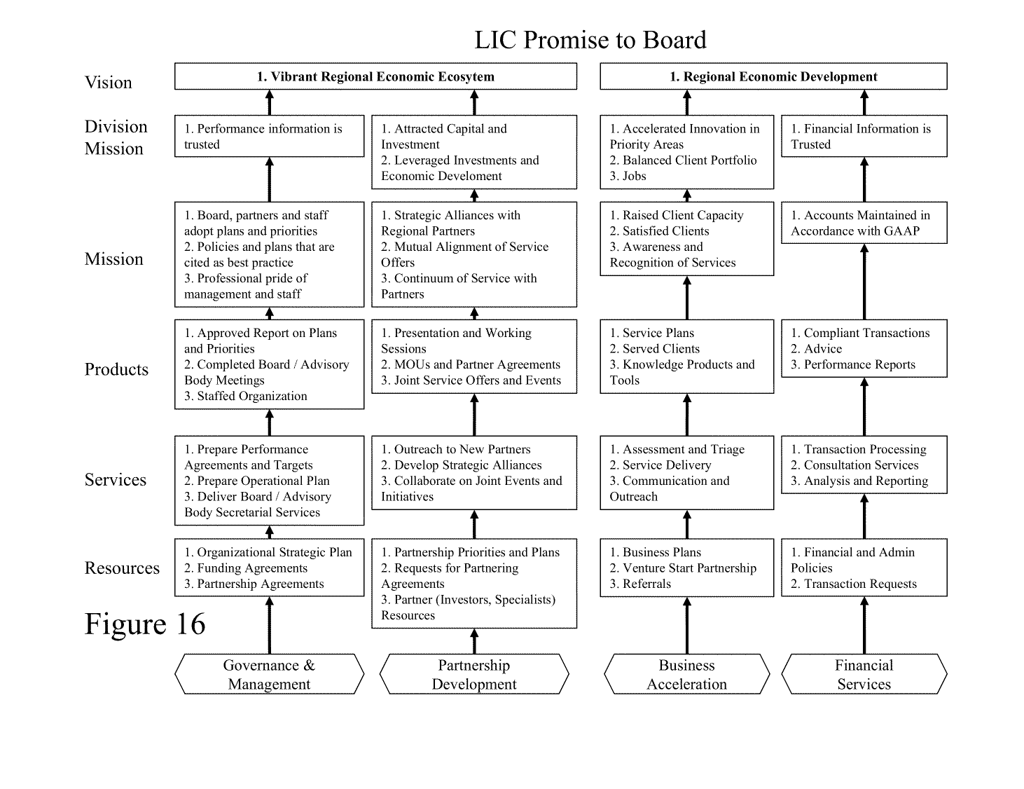

FIG. 16 presents another embodiment of an aspect of the method and system, here the facet chain (terms primarily, some conditions) is for the LIC's promise to its board of directors regarding the promise of FIG. 14 that was developed using another embodiment of the invention described above to create an Activity Result Hierarchy. As seen here, the promise of the LIC to its Board to deliver Services under its Business Acceleration activity stream facet chain is automatically fulfilled as the LIC performs its tasks under the promise of FIG. 14 in accordance with the project facet chain of FIG. 15.

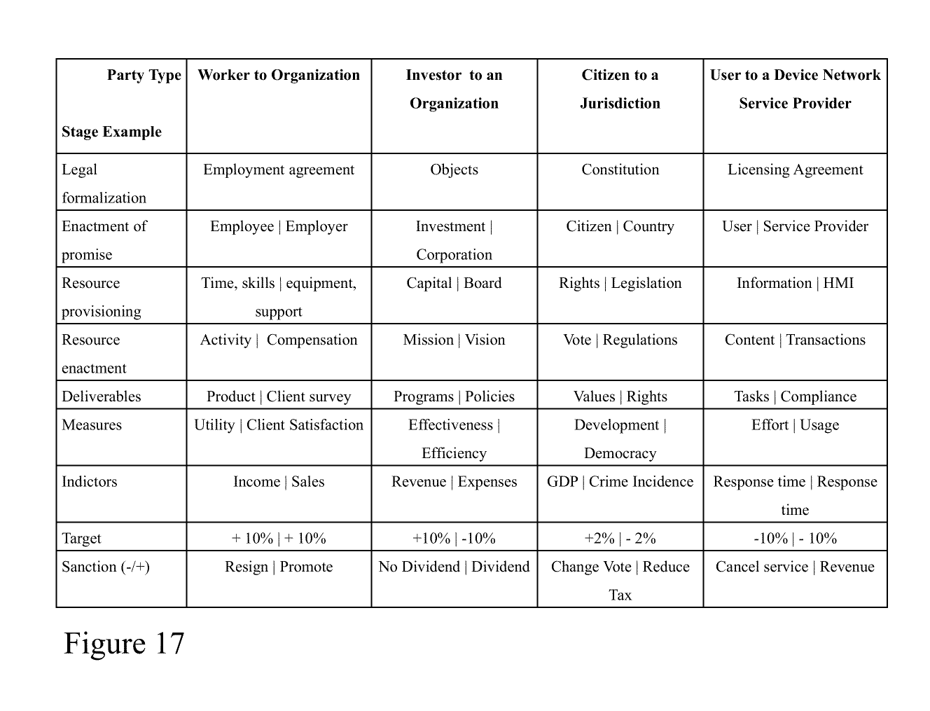

FIG. 17 presents exemplary promises illustrating the vast extent of the method and system by illustrating roles (worker, investor, citizen, system user) of a person who is party to various promises (top row), exemplary stages of a promissory lifecycle (left column), and corresponding means of assessing and sanctioning promise fulfillment by role and stage. This figure illustrates how people and organizations thereof may establish facet chains for their promises, whether as individuals to organizations, investors in corporations, or citizens of jurisdictions, and thus how such facet chains may be linked to enable automated fulfillment of promises among parties to a promise and in turn the automated fulfillment of the promises of each party, for example to remit the sales tax to a jurisdiction on a sales transaction between a corporation and a consumer.

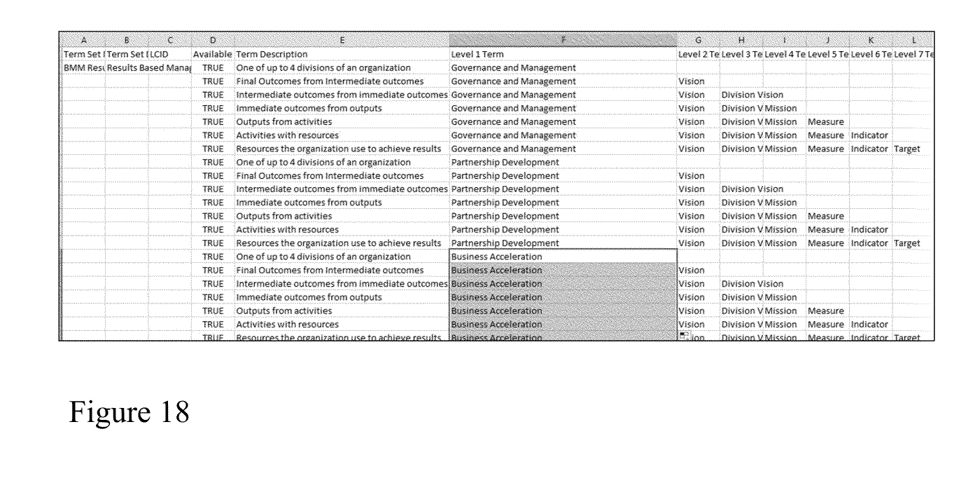

FIG. 18 presents exemplary facet chains for a BPS with a mandate in economic development and arrived at using a discussion board and social media services generally and recorded in a term set format that is machine readable by COTS, cloud and hybrid content management systems. The following summarizes an exemplary embodiment of the Servicebook™ invention, including facet determination, applied recursively over the lifecycle of a promise under the following scenario and using the program theory planning and management method previously established and selected by the parties:

Parties of an RIC and an LIC enter into a promise to plan, deliver and manage an economic development program such as that exemplified in FIG. 14 and to be entered into with multiple companies to accelerate economic development;

Employees of an LIC and members of its board scope the Servicebook™ project to fulfill its obligations under the promise to the RIC to identify and support such companies, including by deciding on the DSET using a discussion board similar to that exemplified by FIG. 8 and the result of which is exemplified in the term set of FIG. 18, this set being part of the requirement for term sets identified in exemplary Scope Step 2 from FIG. 7 for specifying the result hierarchy for achieving economic development;

Employees of an LIC and members of its board complete the Servicebook™ using social media, including arriving at common terms of art for the result hierarchy of FIG. 16;

The DSET for the program is deployed to the LIC's CRM and dashboards are generated as companies apply to the program through a Call for Proposals as exemplified in FIG. 9;

Parties of an RIC, LIC and a company that has successfully applied to the program enter into a promise also exemplified by FIG. 14 and with the common terms of art for the obligations of each exemplified in the work breakdown structure of FIG. 15; and

As the parties to the promise fulfill their obligations by completing the tasks in the WBS, the dashboards of each party are updated in the form of changes to the smiley icons; if a party's Servicebook™ included linkages between the WBS system to its enterprise information system, as is the case with the LIC, the dashboards of personnel at the LIC, possibly including board members and investors, are updated to reflect the extent of the fulfillment of the promise by the LIC in accordance with the LIC's Servicebook™ presented in FIG. 16.

A core aspect of this invention is that of providing methods and systems enabling humans to arrive at an agreement on terms that are machine interpretable. Much prior art exists on the science, technology, culture, politics and philosophy of language, its grammars, how many parts a grammar may have, the various forms, the various rules and exceptions, idioms, translation difficulties, and so forth. As more humans agree to automate their promises, there will be an increasing requirement to execute various forms of a given promise to determine the preferred scenario and reverse the others as enabled by audit trails and other means, for example instructing a machine to emit an antidote for a diabetic injection previously administered under a sub-optimal promise, or for changing a policy to minimizing tax leakage, or to slow down the clocks of the machines implementing a promise, all to better manage or prevent unanticipated impacts of a promise. As evidenced by the emergence of Web 4.0, a core enabling technology will be what is currently provided by the Internet Engineering Task Force (IETF) and its governance and management bodies, as exemplified by Request For Comment 5646 “Tags for Identifying Languages” for well-formed and valid tags, and similar “on-demand” or “real-time” product or industry-specific standard provisioning web services. Note that in the case of RFC 5646 terms such as “Script” and “Variant” and “Language” are understood to pertain to human languages, but machine interpretable languages such as the term set presented in FIG. 18 may also be substituted in several contexts, including private use considerations. Many advances will be made in this field, this invention serves to facilitate the deployment of such advances by providing people and groups thereof to arrive at promises that increase trust and reduce misunderstanding to achieve mutual gain.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, virtual wares, software designed networks and wares, scripting language and/or microcode, the program code or code segments to perform the necessary tasks may be stored in a machine readable medium, such as a digital storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, non-volatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth. If other input or output is required, such as a courier's bar scanner serving as a device to record the receipt of shipment, or one or more sensors such as that enabling fingerprint logon to authenticate a user, then the processing system also includes such sensors and input/output devices.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a cluster of smartphones, a web appliance, a distributed computing environment, a cloud computing environment, or any machine capable of executing a set of instructions (sequential or otherwise) that specify actions to be taken by that machine. The term “machine” may also be taken to include any collection of machines or virtual machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and performed by various agents and still remain within the spirit and scope of the present invention.

What is claimed is:

1. A method comprising:
a) providing on a microprocessor based computer system accessible via a network a group multimedia discussion system and an associated social media system for use by at least a participant of a plurality of participants;
b) providing to each participant of the plurality of participants on a microprocessor based device associated with the participant connected to the network access to the group discussion system such that a decision as to the selection of a selected management method of a plurality of potential management methods is documented together with all discussions between the plurality of participants leading to the decision;
c) providing on the microprocessor based computer system a plurality of grids, each grid of the plurality of grids for facilitating discussions and detailing decisions arrived at by users in conjunction with the group discussion system and being part of a multistage process relating to the establishment of at least one of a program or a service or a planning and management method, and a performance indicator relating to achieving a mandate;
d) providing to each participant of a predetermined subset of the plurality of participants on their microprocessor based device connected to the network access to at least a grid of a predetermined subset of grids of the plurality of grids, the predetermined subset of grids being determined in dependence upon at least the participant and the selected planning and management method; and
e) providing in association with each grid of the predetermined subset of grids participant guidelines for use by each participant of the plurality of participants to guide said discussions in said group discussion system.

2. The method according to claim 1 further comprising;
f) pre-populating a predetermined portion of a first grid of the predetermined subset of grids with a predetermined subset of content within a second grid of the predetermined subset of grids, the first and second grids of the predetermined subset of grids being sequential grids within a predetermined sequence of grids determined in dependence upon the selected planning and management method.

3. The method according to claim 1 wherein,
providing access to a participant comprises receiving from the participant credentials and granting the participant access to discussions with respect to a grid, the access determined in dependence upon successful validation of the credentials and the credentials received.

4. The method according to claim 1 wherein,
the predetermined subset of grids of the plurality of grids are determined in dependence upon at least the selection of a predetermined planning and management method by a predetermined subset of the participants charged with achieving a specified mandate.

5. The method according to claim 1 wherein,
the predetermined subset of grids of the plurality of grids is determined in dependence upon a selected planning and management template.

6. The method according to claim 5 wherein,
the selected planning and management template is at least one of generated by an enterprise directly, based upon a preceding planning and management template executed by an enterprise, based upon a planning and management template relating to a partner organization of an enterprise, selected from a database of planning and management templates, and procured from a third party.

7. The method according to claim 1 wherein,
the guidelines comprise first content relating to what rows and columns are present in the grid, second content relating to parsing errors that may be present in the discussion, third content relating to logical fallacies that may be present in the discussion, fourth content relating to different types of performance assessment options available for the grid, and fifth content relating to result accountability and enforcement options.

8. The method according to claim 1 wherein,
discussions relating to a predetermined grid of the plurality of grids for the plurality of participants are guided by a moderator.

9. A method according to claim 1 further comprising;
f) receiving from a predetermined subset of the plurality of participants completed entries within the predetermined grid of the plurality of grids and collating the completed entries to generate a completed project grid, the completed entries relating to decisions made during said discussions.

10. A method according to claim 1 further comprising;
f) generating a configuration file for use in reconfiguring at least one of a client relationship management, enterprise information system or other management information system, the configuration file reflecting decisions made by the plurality of participants and the entries in the predetermined subset of the plurality of grids completed by said participants.

11. The method according to claim 1 further comprising,
f) pre-populating a predetermined portion of a grid of the predetermined subset of grids with a predetermined subset of content from a completed grid from a previous stage in the multistage process;
g) notifying a second predetermined subset of the plurality of participants that the grid of the predetermined subset of grids has been pre-populated to initiate discussions directed to completing the second grid of the predetermined subset of grids; and
h) determining whether notifications should be sent to at least one invitee of a plurality of invitees indicating that the grid of the predetermined subset of grids has been pre-populated and inviting them to join the discussions directed to completing the second grid of the predetermined subset of grids.

12. A system comprising:
a) a microprocessor based computer system accessible via a network comprising at least a physical non-volatile memory
b) a group discussion module for use by the plurality of participants, the group discussion module allowing each participant of the plurality of participants to employ a microprocessor based device associated with the participant connected to the network access to the group discussion system such that a decision as to the selection of selected planning and management method of a plurality of potential planning and management methods is documented together with all discussions between the plurality of participants leading to the decision;
c) a plurality of grids stored within the memory of the microprocessor based computer system, each grid of the plurality of grids for facilitating discussions and detailing decisions arrived at by users in conjunction with the group discussion system and being part of a multistage process relating to the establishment of at least one of a program or a service or a planning and management method, and a performance indicator relating to achieving a mandate;
d) a grid module for use by each participant of a predetermined subset of the plurality of participants, the grid module allowing each participant of the predetermined subset of the plurality of participants on their microprocessor based device connected to the network access to at least a grid of a predetermined subset of grids of the plurality of grids, the predetermined subset of grids being determined in dependence upon at least the participant and the selected planning and management method; and
e) a guideline module for use in association with each grid of the predetermined subset of grids, the guideline module providing to participants guidelines and tools for use by each participant to guide said discussions in said group discussion system.

13. The system according to claim 12 further comprising;
f) pre-populating a predetermined portion of a first grid of the predetermined subset of grids with a predetermined subset of content within a second grid of the predetermined subset of grids, the first and second grids of the predetermined subset of grids being sequential grids within a predetermined sequence of grids determined in dependence upon the selected planning and management method.

14. The system according to claim 12 further comprising;
an access module for controlling access to the system by a participant, the access module receiving from the participant credentials and granting the participant access to discussions with respect to a grid, the access determined in dependence upon successful validation of the credentials and the credentials received.

15. The system according to claim 12 wherein,
the predetermined subset of grids of the plurality of grids are determined in dependence upon at least the selection of a predetermined planning and management method by a predetermined subset of the participants charged with achieving a specified mandate and a selected planning and management template.

16. The system according to claim 15 wherein,
the selected planning and management template is at least one of generated by an enterprise directly, based upon a preceding planning and management template executed by an enterprise, based upon a planning and management template relating to a partner organization of an enterprise, selected from a database of planning and management templates, and procured from a third party.

17. The system according to claim 12 wherein,
the discussion module comprises a moderator module relating to a predetermined grid of the plurality of grids such that the discussions between the predetermined subset of the plurality of participants are guided by a moderator who accesses the discussion via the moderator module.

18. A system according to claim 12 further comprising;
f) receiving from a predetermined subset of the plurality of participants completed entries within the predetermined grid of the plurality of grids and collating the completed entries to generate a completed project grid, the completed entries relating to decisions made during said discussions.

19. A system according to claim 12 further comprising;
f) generating a configuration file for use in reconfiguring at least one of a client relationship management, enterprise information system or other management information system, the configuration file reflecting decisions made by the plurality of participants and the entries in the predetermined subset of the plurality of grids completed by said participants.

20. The system according to claim 12 further comprising,
f) pre-populating a predetermined portion of a grid of the predetermined subset of grids with a predetermined subset of content from a completed grid from a previous stage in the multistage process;
g) notifying a second predetermined subset of the plurality of participants that the grid of the predetermined subset of grids has been pre-populated to initiate discussions directed to completing the second grid of the predetermined subset of grids; and
h) determining whether notifications should be sent to at least one invitee of a plurality of invitees indicating that the grid of the predetermined subset of grids has been pre-populated and inviting them to join the discussions directed to completing the second grid of the predetermined subset of grids.

21. A method for planning and managing the fulfillment of a promise made by an enterprise and associated business planning and management information relating to business, programs and services for the enterprise, the method comprising:
providing upon a computer system an online group discussion system and an associated social media system, each said system being for use by participants involved in said enterprise;
generating with a microprocessor associated with the computer system at least a grid of a plurality of grids and associated social media services within the social media system based upon a promise identified and selected by said participants, said grid for completion by said participants, each grid of the plurality of grids for detailing planning information and decisions arrived at by said participants in discussions using said social media system, said decisions being part of a stage of a multistage process to fulfill the promise;
providing via the computer system the plurality of grids and associated social media services to said participants for completion by said participants;
providing a credential based access to the computer system for said participants to at least one of participate in and contribute to discussions in accordance with their credentials in said group discussion system;
providing a plurality of at least one of guidelines and tools, each of said at least one for use by said participants to guide said discussions and contributions and facilitate establishment and recordation of decisions within said group discussion system by the participants.

22. A method according to claim 21 wherein said method further comprises providing a non-volatile digital memory associated with the enterprise for storage of the plurality of grids.

23. The method according to claim 21 wherein,
the plurality of guidelines and tools allow participants to determine at least one of:
what rows and columns may be present within a grid;
the interdependencies between those rows and columns within a grid;
the content of those rows and columns within a grid;
the connection of a grid to one or more other grids within the plurality of grids;
logical fallacies that may be present in at least one of the plurality of grids and their content;
syntax errors that may be present in at least one of the grids and their content;
configuration parameters for generating dashboards for presentation to other participants;
configuration parameters for sanctioning involved participants;
metadata profiling the configuration parameters of at least one of the group discussion system and the associated social media system; and
metadata profiling the performance of the enterprise in fulfilling the promise.

24. The method according to claim 21 wherein discussions between participants within the group discussion system at least one of include a moderator, are supported by subject matter experts, and are supported by at least one of network services, online services, and web services through the discussion and associated social media system.

25. The method according to claim 21 further comprising;
at least one of:
receiving a completed grid from said participants, the completed grids being based on contributions and decisions made during said discussions; and
providing one or more configuration parameters for use in reconfiguring said enterprise's client relationship management system, enterprise information system or other management information system to reflect said decisions, said configuration parameters being based on entries in said grids completed by or contributed to by said participants.

26. The method according to claim 21 wherein;
at least one of:
each grid of the plurality of grids is provided in an uncompleted form to said participants using the online group discussion system and associated social media system;
each grid of the plurality of grids is validated using a checklist provided to said participants by the online group discussion system and associated social media system;
a predetermined grid of the plurality of grids is provided to said participants upon completion of a preceding stage in a multi-stage process; and
participant entries within the plurality of grids are used as a basis to produce a configuration file for use in reconfiguring at least one of a client relations management system, enterprise information system, or other management information system of said enterprise.

27. A method for establishing planned results and performance indicators for said planned results for a business enterprise, the method comprising:
executing a multi-stage process upon a computer system accessible by participants in said enterprise via a network, each stage in the multi-stage process comprising;
providing at least one grid for completion by participants in said enterprise, said at least one grid detailing decisions made by said participants regarding issues relating to said results and indicators;
providing a discussion group system for discussions by said participants, said participants logging in to said discussion group system to participate in said discussions;
receiving at least one completed grid from said participants at an end of a stage in said process;
providing a non-volatile digital memory for storage of completed grids;
providing a configuration file for use in reconfiguring a client relationship management system, enterprise information system or other management information system of said enterprise, said configuration file being based on completed forms from said participants.
